(19) United States
(12) Patent Application Publication
(10) Pub. No.: US 2010/0261925 A1
(43) Pub. Date: Oct. 14, 2010

(54) METHOD FOR PRODUCING SILICON COMPOUND

(75) Inventors: Hisashi Nakagawa, Ibaraki (JP); Youhei Nobe, Ibaraki (JP); Kenji Ishizuki, Mie (JP); Terukazu Kokubo, Ibaraki (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: JSR Corporation, Tokyo (JP)

(21) Appl. No.: 12/668,523

(22) PCT Filed: Jul. 8, 2008
(86) PCT No.: PCT/JP08/62327

§ 371 Date: May 7, 2010

(30) Foreign Application Priority Data
Jul. 10, 2007 (JP) 2007-180930
Jan. 31, 2008 (JP) 2008-020296
Jan. 31, 2008 (JP) 2008-020297
Jan. 31, 2008 (JP) 2008-020298

(51) Int. Cl. C07F 7/18

(52) U.S. Cl. 556/435; 556/431

(57) ABSTRACT

A method of producing a silicon compound shown by the following general formula (7) includes reacting an organomagnesium compound shown by the following general formula (1) with an organosilane compound shown by the following general formula (2) in a solvent that contains at least one compound selected from a compound shown by the following general formula (3), a compound shown by the following general formula (4), a compound shown by the following general formula (5), and a compound shown by the following general formula (6).

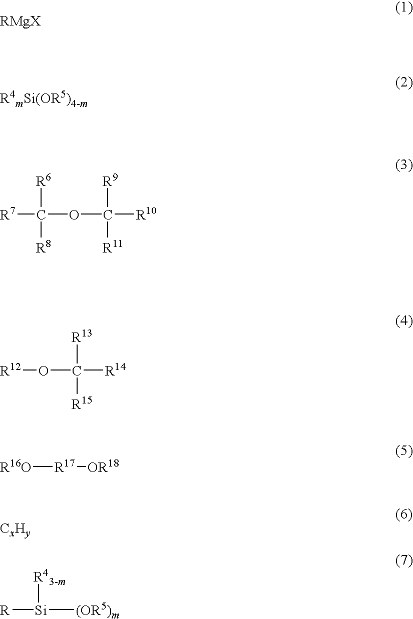

### TECHNICAL FIELD

The present invention relates to a method of producing a silicon compound.

### BACKGROUND ART

In recent years, an increase in processing speed has been strongly desired for ultra-large scale integrated (ULSI) circuits in order to deal with an increase in the volume of information processing and the degree of functional complexity. An increase in ULSI processing speed has been implemented by reducing the size of elements provided in a chip, increasing the degree of integration of elements, and forming a multi-layer film. However, an increase in wiring resistance and wiring parasitic capacitance occurs due to a reduction in size of elements so that a wiring delay predominantly causes a signal delay of the entire device. In order to solve this problem, it is indispensable to use a low-resistivity wiring material or a low-dielectric-constant (low-k) interlayer dielectric material.

As a wiring material, Cu that is a low-resistivity metal has been studied and used instead of Al. As an interlayer dielectric material, a silica (SiO₂) film formed by a vacuum process such as chemical vapor deposition (CVD) has been widely used. Various proposals have been made to form a low-dielectric-constant (low-k) interlayer dielectric.

Examples of such a low-dielectric-constant interlayer dielectric include a porous silica film formed by reducing the film density of silica (SiO₂), an inorganic interlayer dielectric such as a silica film doped with F (FSG) and an SiOC film doped with C, and an organic interlayer dielectric such as a polyimide, polyarylene, and polyarylene ether.

A coating-type insulating film (SOG film) that contains a hydrolysis-condensation product of a tetraalkoxysilane as the main component, and an organic SOG film formed of a polysiloxane obtained by hydrolysis and condensation of an organic alkoxysilane, have also been proposed in order to form a more uniform interlayer dielectric.

An interlayer dielectric is formed as follows. An interlayer dielectric is generally formed by a coating method (spin coating method) or chemical vapor deposition (CVD). The coating method forms a film by applying an insulating film-forming polymer solution using a spin coater or the like. CVD introduces a reaction gas into a chamber and deposits a film utilizing a gas-phase reaction.

An inorganic material and an organic material have been proposed for the coating method and CVD. A film with excellent uniformity is generally obtained by the coating method. However, a film obtained by the coating method may exhibit inferior adhesion to a substrate or a barrier metal. A film obtained by CVD may exhibit poor uniformity or a dielectric constant that is not sufficiently reduced. On the other hand, an interlayer dielectric deposited by CVD has been widely used due to an operational advantage and excellent adhesion to a substrate. Therefore, CVD has an advantage over the coating method.

Various films obtained by CVD have been proposed. In particular, a number of films characterized by a silane compound used for a reaction have been proposed. For example, a film obtained using a dialkoxysilane (JP-A-11-288931 and JP-A-2002-329718), a film obtained using a cyclic silane compound (JP-T-2002-503879 and JP-T-2005-513766), and a film obtained using a silane compound in which a tertiary carbon atom or a secondary carbon atom is bonded to Si (JP-A-2004-6607 and JP-A-2005-51192) have been disclosed. A film having a low dielectric constant and excellent adhesion to a barrier metal or the like may be obtained using such a material.

However, such a silane compound may require extreme conditions during CVD due to chemical stability, or may undergo a reaction in a pipe connected to a chamber due to chemical instability, or may exhibit poor storage stability. A semiconductor device production process generally involves a step that processes an interlayer dielectric using reactive ion etching (RIE). The dielectric constant of a film may increase during RIE, or an interlayer dielectric may be damaged by a fluorine acid-based chemical used in the subsequent washing step. Therefore, an interlayer dielectric having high process resistance has been desired.

The applicant of the present application has proposed a silicon compound that contains one silicon atom bonded to a carbon chain wherein an alkoxy group is bonded to the silicon atom, and demonstrated that an insulating film produced using the silicon compound exhibits excellent chemical resistance (see JP-A-2005-350653, for example). It is useful to use a Grignard reaction when synthesizing these compounds.

However, some problems occur when using this method. Specifically, the rate of the coupling reaction between the Grignard reagent and an alkoxysilane is low. It may take more than ten hours for the reaction to complete when using a reaction solvent that has been generally used. This is disadvantageous from the viewpoint of industrial production.

Moreover, it is necessary to remove by-product magnesium salts after the coupling reaction. Since the silicon compound (i.e., main product) is hydrolyzable, liquid-phase extraction using water or an acidic aqueous solution cannot be used when removing magnesium salts. Therefore, magnesium salts must be removed by filtration, a tilt method, supernatant extraction, or the like. The separation method using filtration takes time since the amount of salts is large when synthesizing a large amount of silicon compound. The separation method using a tilt method, supernatant extraction, or the like is convenient as compared with the separation method using filtration. However, since the dispersity of by-product magnesium salts is high when synthesizing the silicon compound using a solvent that has been generally used, it is normally indispensable to perform a precipitation operation using centrifugation or the like.

A method that removes magnesium salts produced during a Grignard reaction by liquid-phase extraction using a non-aqueous solution is known in the art (Japanese Patent No. 3656168). However, Japanese Patent No. 3656168 discloses removing a magnesium halide that is relatively easily dissolved in a polar solvent. Therefore, it is difficult to apply the method disclosed in Japanese Patent No. 3656168 to a magnesium alkoxide due to poor solubility. Moreover, since Japanese Patent No. 3656168 utilizes liquid-phase extraction between organic solvents, the distribution ratio of the target product to the non-polar solvent phase is small. Therefore, it is necessary to use a large amount of non-polar solvent.

### DISCLOSURE OF THE INVENTION

The invention may provide a method of producing a silicon compound that enables a product to be obtained in high yield by a simple process while reducing the reaction time of a synthesis process using a Grignard reaction.

According to one aspect of the invention, there is provided a method of producing a silicon compound shown by the following general formula (7), the method comprising reacting an organomagnesium compound shown by the following general formula (1) with an organosilane compound shown by the following general formula (2) in a solvent that contains at least one compound selected from a compound shown by the following general formula (3), a compound shown by the following general formula (4), a compound shown by the following general formula (5), and a compound shown by the following general formula (6),

RMgX (1)

wherein R represents a monovalent organic group, and X represents a halogen atom,

R⁴ₘSi(OR⁵)₄₋ₘ (2)

wherein R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, and m represents an integer from 0 to 2,

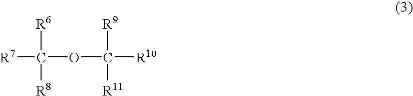

wherein R⁶ and R⁷ individually represent a monovalent organic group, and R⁸ to R¹¹ individually represent a hydrogen atom or a monovalent organic group, provided that any of R⁶ to R⁸ or any of R⁹ to R¹¹ may form a cyclic structure,

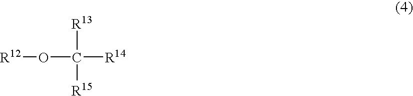

wherein R¹² represents an aryl group, and R¹³ to R¹⁵ individually represent a hydrogen atom or a monovalent organic group, provided that any of R¹³ to R¹⁵ may form a cyclic structure,

R¹⁶O—R¹⁷—OR¹⁸ (5)

wherein R¹⁶ and R¹⁸ individually represent an alkyl group having 1 to 6 carbon atoms, a vinyl group, or a phenyl group, and R¹⁷ represents an alkylene group having 1 to 6 carbon atoms, an alkenylene group having 2 to 6 carbon atoms, or a phenyl group, provided that R¹⁶ and R¹⁸ may form a cyclic structure,

CₓH_{y} (6)

wherein x represents an integer from 4 to 20, and y represents an integer from 6 to 42,

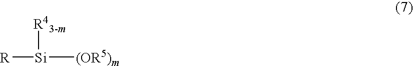

wherein R represents a monovalent organic group, R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, and m represents an integer from 0 to 2.

In the above method of producing a silicon compound, the organomagnesium compound shown by the general formula (1) may be an organomagnesium compound shown by the following general formula (8), and the silicon compound shown by the general formula (7) may be a silicon compound shown by the following general formula (9),

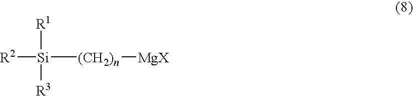

wherein R¹ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group, X represents a halogen atom, and
n represents an integer from 1 to 3,

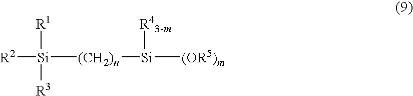

wherein R¹ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group, R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, m represents an integer from 0 to 2, and n represents an integer from 1 to 3.

In this case, n in the general formulas (8) and (9) may be one.

The above method of producing a silicon compound may further comprise reacting an alkyl halide shown by the following general formula (10) with magnesium to produce the organomagnesium compound shown by the general formula (1),

RX (10)

wherein R represents a monovalent organic group, and X represents a halogen atom. According to the above method of producing a silicon compound, since the compound shown by the general formula (1) and the compound shown by the general formula (2) are subjected to a Grignard reaction in a solvent that contains at least one compound selected from the compound shown by the general formula (3), the compound shown by the general formula (4), the compound shown by the general formula (5), and the compound shown by the general formula (6), the reaction time can be reduced, by-product magnesium salts can be removed by a convenient step, and the silicon compound shown by the general formula (7) can be obtained in high yield.

### BRIEF DESCRIPTION OF THE DRAWINGS

FIG. 1 is a view showing the extent of reaction in the examples and comparative examples.

FIG. 2 is a view showing the measurement results for the degree of precipitation in the examples and comparative examples.

### BEST MODE FOR CARRYING OUT THE INVENTION

The invention is described in detail below.

### 1. Method of Producing Silicon Compound

### 1.1. Production Method

A method of producing a silicon compound according to this embodiment is a method of producing a silicon compound shown by the following general formula (7), the method comprising reacting an organomagnesium compound shown by the following general formula (1) (hereinafter may be referred to as “compound 1”) with an organosilane compound shown by the following general formula (2) (hereinafter may be referred to as “compound 2”) in a solvent that contains at least one compound selected from a compound shown by the following general formula (3) (hereinafter may be referred to as “compound 3”), a compound shown by the following general formula (4) (hereinafter may be referred to as “compound 4”), a compound shown by the following general formula (5) (hereinafter may be referred to as “compound 5”), and a compound shown by the following general formula (6) (hereinafter may be referred to as “compound 6”),

RMgX (1)

wherein R represents a monovalent organic group, and X represents a halogen atom.

R⁴ₘSi(OR⁵)₄₋ₘ (2)

wherein R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, and m represents an integer from 0 to 2,

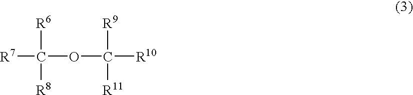

wherein R⁶ and R⁷ individually represent a monovalent organic group, and R⁸ to R¹¹ individually represent a hydrogen atom or a monovalent organic group, provided that any of R⁶ to R⁸ or any of R⁹ to R¹¹ may form a cyclic structure,

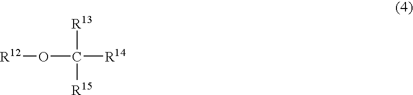

wherein R¹² represents an aryl group, and R¹³ to R¹⁵ individually represent a hydrogen atom or a monovalent organic group, provided that any of R¹³ to R¹⁵ may form a cyclic structure,

R¹⁶O—R¹⁷—OR¹⁸ (5)

wherein R¹⁶ and R¹⁸ individually represent an alkyl group having 1 to 6 carbon atoms, a vinyl group, or a phenyl group, and R¹⁷ represents an alkylene group having 1 to 6 carbon atoms, an alkenylene group having 2 to 6 carbon atoms, or a phenyl group, provided that R¹⁶ and R¹⁸ may form a cyclic structure,

CₓH_{y} (6)

wherein x represents an integer from 4 to 20, and y represents an integer from 6 to 42,

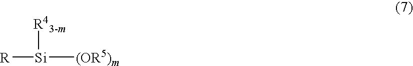

wherein R represents a monovalent organic group, R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, and m represents an integer from 0 to 2.

The details are described below.

Specifically, an alkyl halide shown by following general formula (10) (hereinafter may be referred to as “compound 10”) is reacted with magnesium to produce an organomagnesium compound (compound 1). When a solvent used when producing a silicon compound (compound 7) contains at least one compound selected from the compounds 3 to 5, the above reaction is preferably carried out using the same solvent as the solvent used when producing the silicon compound (compound 7). When a solvent used when producing the silicon compound (compound 7) is the compound 6, the above reaction is preferably carried out using an ether solvent such as diethyl ether, isopropyl ether, methyl tert-butyl ether, tetrahydrofuran, or dioxane.

The alkyl halide (compound 10) and magnesium are mixed so that the amount of magnesium is 0.7 to 1.5 mol based on 1 mol of the alkyl halide. If the amount of magnesium is less than 0.7 mol, the raw material may be consumed to only a small extent. If the amount of magnesium is more than 1.5 mol, a large amount of magnesium may remain unreacted.

The reaction temperature is preferably 0 to 100° C. If the reaction temperature is lower than 0° C., the reaction may proceed to only a small extent. If the reaction temperature is higher than 100° C., the reaction may not be sufficiently controlled.

RX (10)

wherein R represents a monovalent organic group, and X represents a halogen atom.

The organosilane compound (compound 2) shown by the general formula (2) is added to the organomagnesium compound (Grignard reagent) produced in the solvent, and the compounds are reacted in a solvent that contains at least one compound selected from the compounds 3 to 6.

The organomagnesium compound (compound 1) and the organosilane compound (compound 2) are mixed so that the amount of the organosilane compound is 0.7 to 10 mol based on 1 mol of the organomagnesium compound. The reaction temperature is preferably 0 to 250° C., and more preferably 40 to 150° C.

### 1.2. Organomagnesium Compound (Compound 1)

Each material used in the above step and the product are described below.

The organomagnesium compound (compound 1) used in the method of producing a silicon compound according to this embodiment is preferably a compound that contains silicon to which at least one hydrogen or hydrocarbon group is bonded. Specifically, the organomagnesium compound (compound 1) is preferably an organomagnesium compound shown by the following general formula (8).

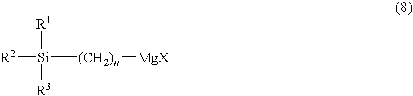

wherein R¹ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group, X represents a halogen atom, and n represents an integer from 1 to 3.

The alkoxy group in the general formula (8) preferably has 1 to 10 carbon atoms, and more preferably 3 to 10 carbon atoms.

Examples of such an organomagnesium compound include the following compounds.

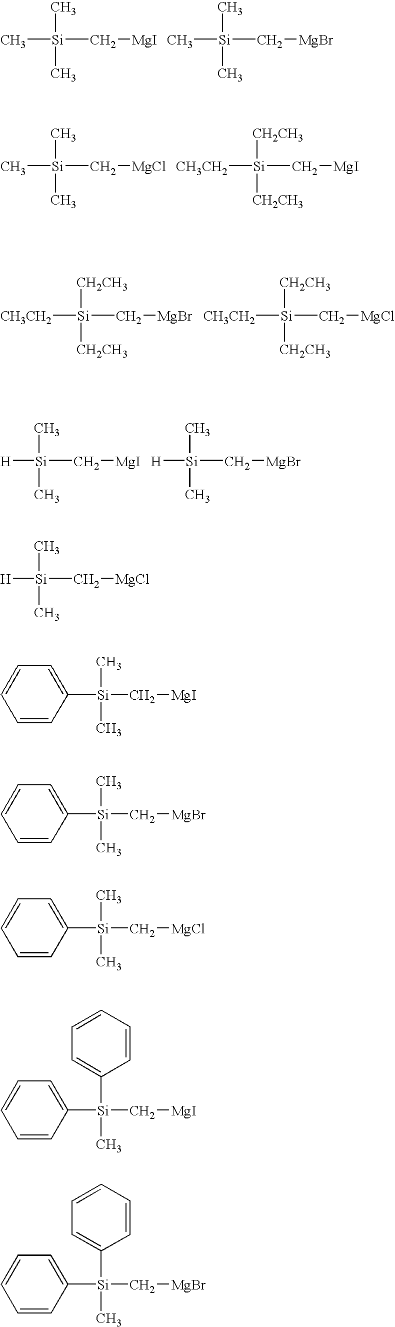

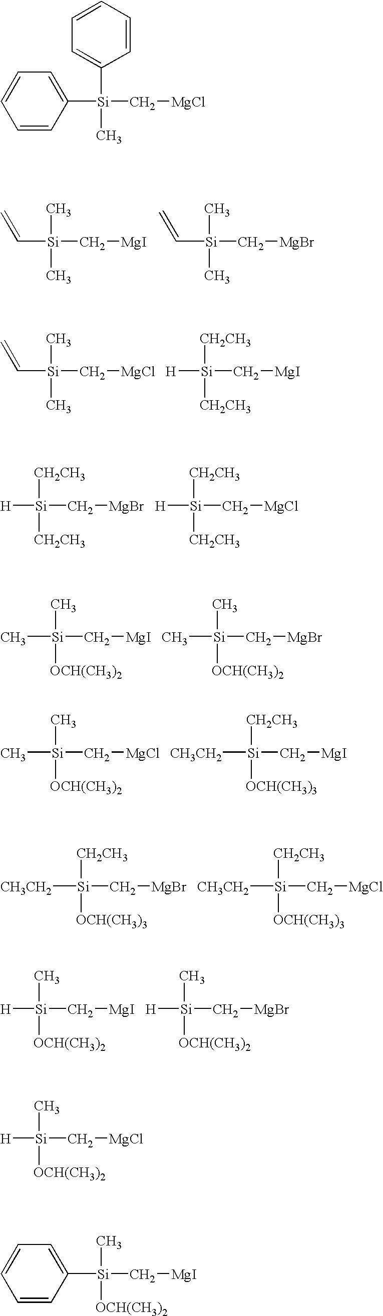

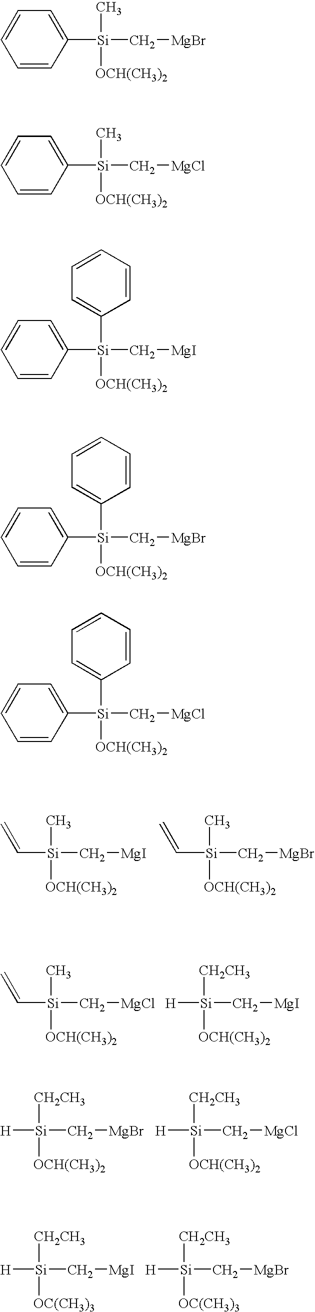

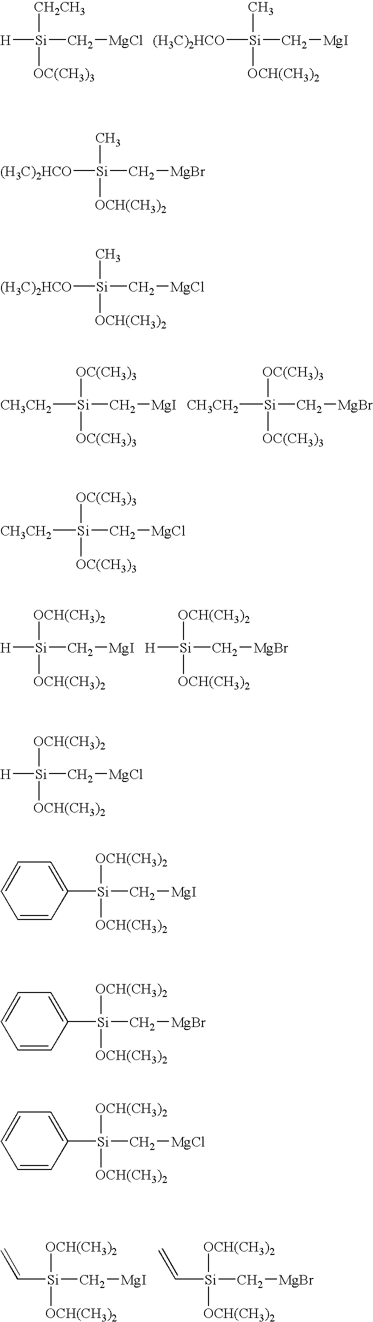

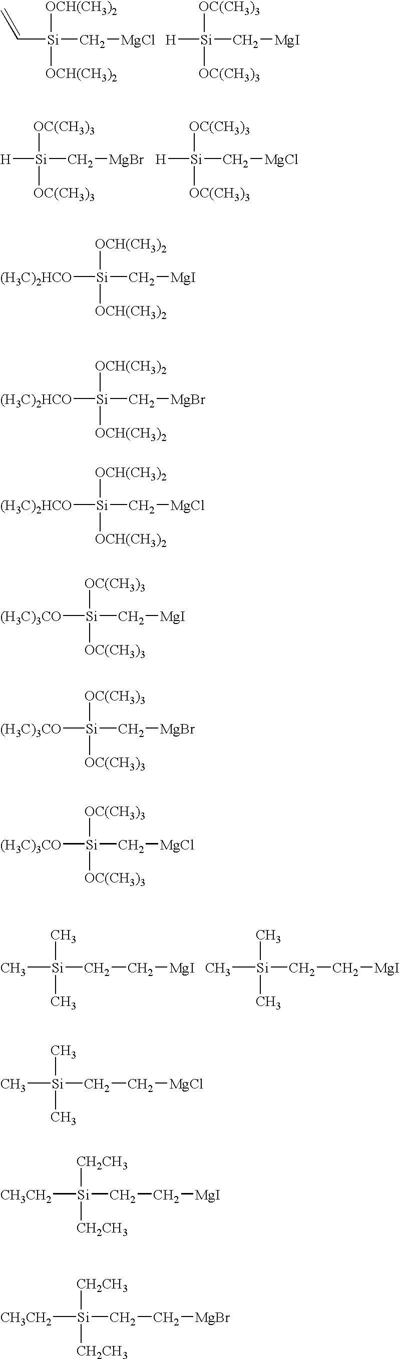

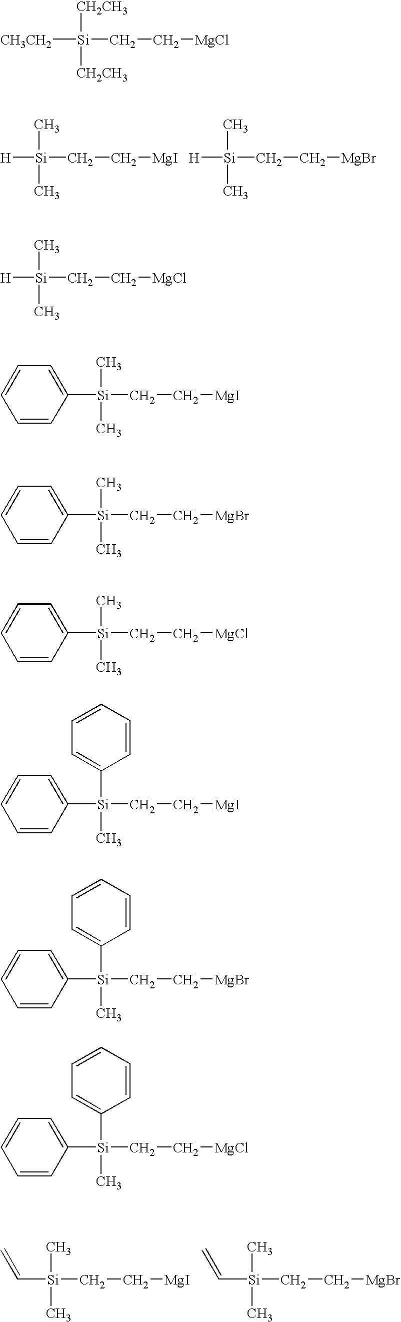

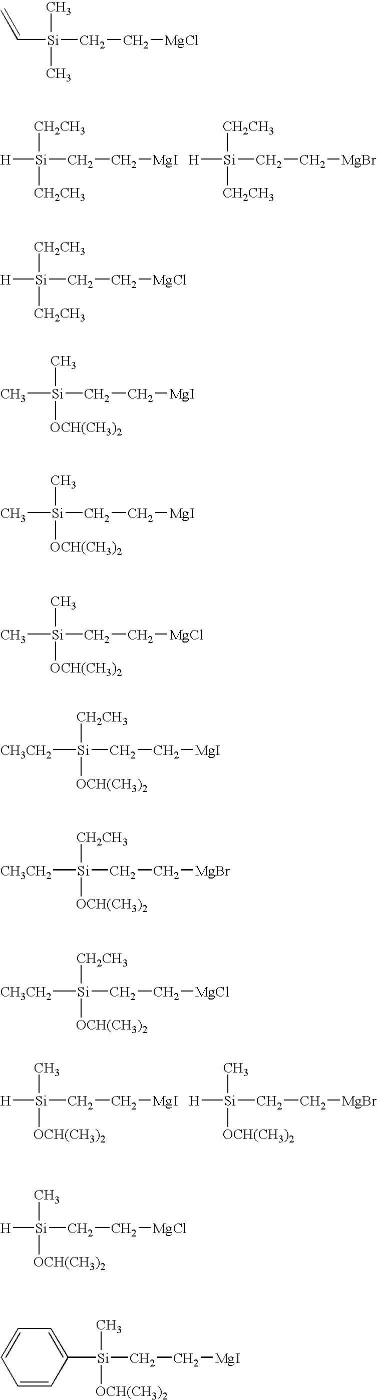

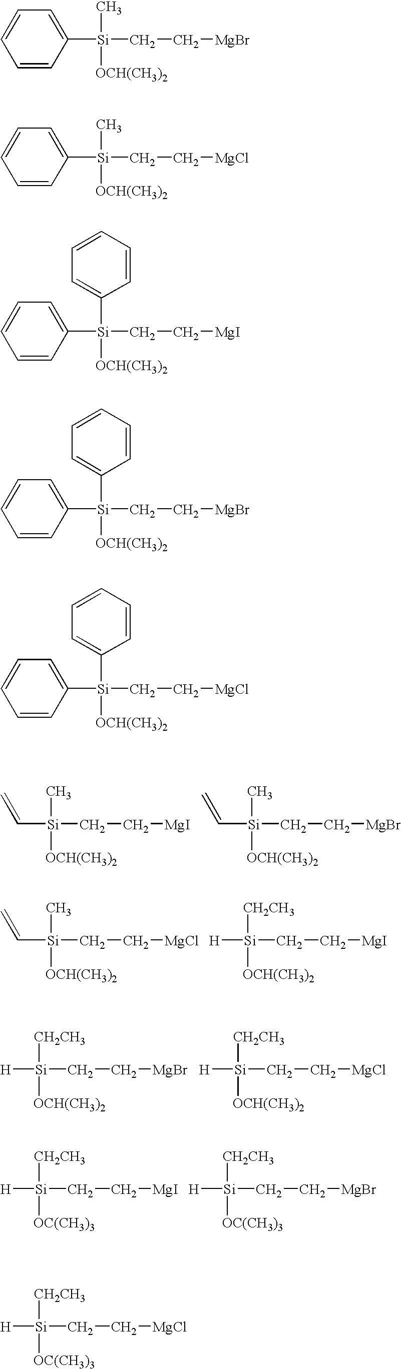

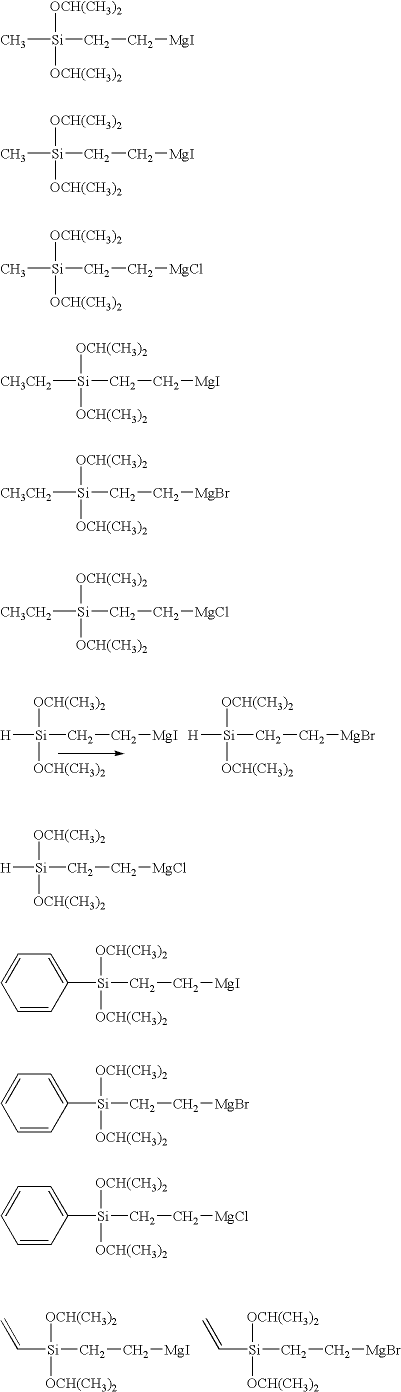

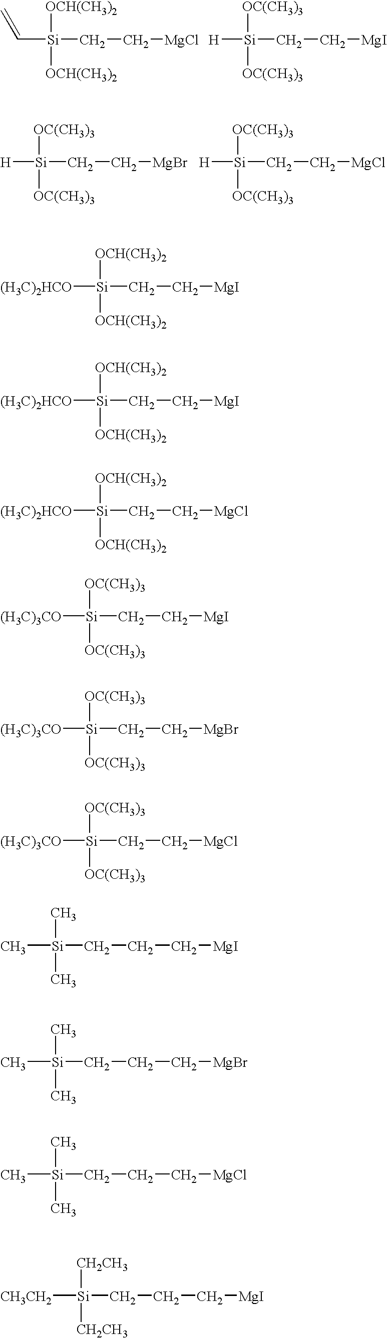

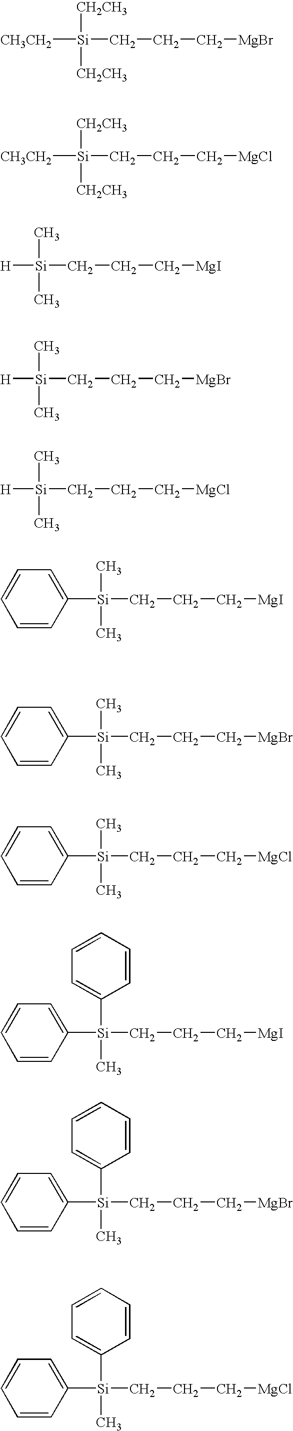

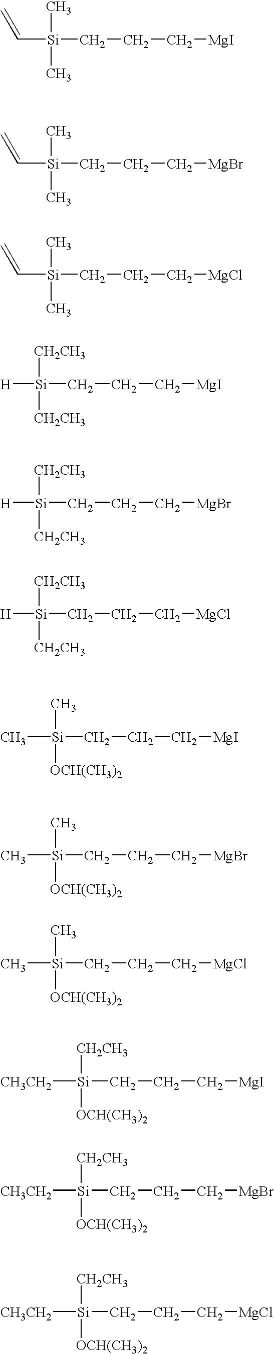

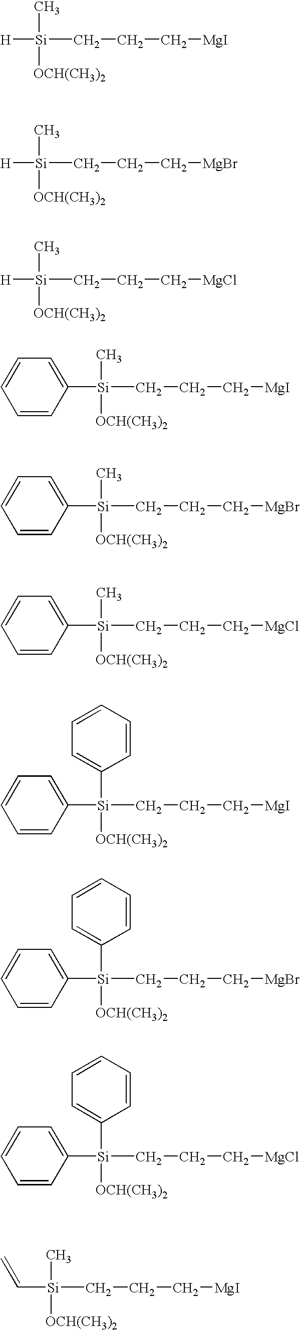

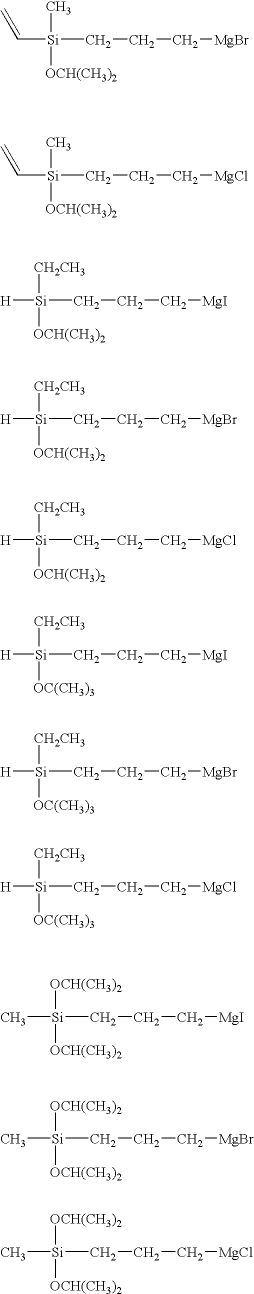

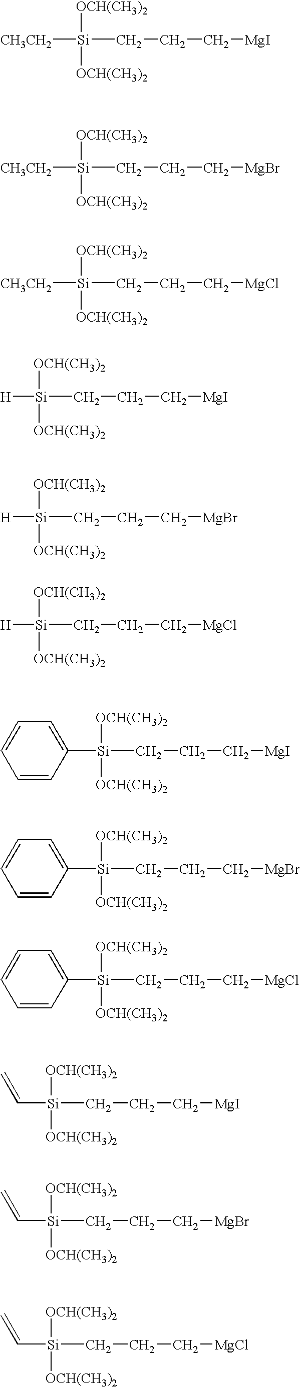

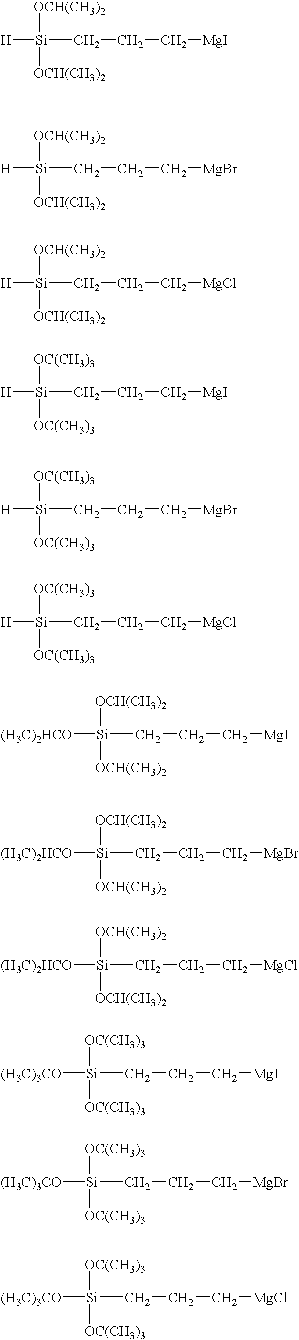

### 1.3. Organosilane Compound (Compound 2)

The organosilane compound (compound 2) used in the method of producing a silicon compound according to this embodiment is shown by the general formula (2).

Examples of the substituent R⁴ in the general formula (2) include a methyl group, an ethyl group, an n-propyl group, an isopropyl group, an n-butyl group, an isobutyl group, a sec-butyl group, a vinyl group, an aryl group, and the like.

Examples of the substituent OR⁵ in the general formula (2) include a methoxy group, an ethoxy group, a vinyloxy group, an n-propoxy group, an isopropoxy group, an n-butoxy group, an isobutoxy group, a sec-butoxy group, a phenoxy group, and the like. Examples of the organosilane compound shown by the general formula (2) include methyltrimethoxysilane, methyltriethoxysilane, methyltriisopropoxysilane, methyltri-n-propoxysilane, methyltriisobutoxysilane, methyltri-n-butoxysilane, methyltriacetoxysilane, methyltriphenoxysilane, trimethoxysilane, triethoxysilane, triisopropoxysilane, tri-n-propoxysilane, triisobutoxysilane, tri-n-butoxysilane, triacetoxysilane, triphenoxysilane, ethyltrimethoxysilane, ethyltriethoxysilane, vinyltrimethoxysilane, vinyltriethoxysilane, phenyltrimethoxysilane, phenyltriethoxysilane, phenyltriisopropoxysilane, phenyltriacetoxysilane, dimethyldimethoxysilane, dimethyldiethoxysilane, dimethyldiisopropoxysilane, dimethyldi-n-propoxysilane, dimethyldiisobutoxysilane, dimethyldi-n-butoxysilane, dimethyldiacetoxysilane, dimethyldiphenoxysilane, methyldimethoxysilane, methyldiethoxysilane, methyldiisopropoxysilane, methyldi-n-propoxysilane, methyldiisobutoxysilane, methyldi-n-butoxysilane, methyldiacetoxysilane, methyldiphenoxysilane, methylphenyldimethoxysilane, methylphenyldiethoxysilane, methylphenyldiisopropoxysilane, diethyldimethoxysilane, diethyldiethoxysilane, methylvinyldimethoxysilane, methylvinyldiethoxysilane, tetramethoxysilane, tetraethoxysilane, tetraisopropoxysilane, tetra-n-propoxysilane, tetraisobutoxy silane, tetra-n-butoxysilane, tetraacetoxysilane, tetraphenoxysilane, and the like.

### 1.4. Solvent

In the method of producing a silicon compound (compound 7) according to this embodiment, a solvent that contains at least one compound selected from the compounds 3 to 6 may be used. The compounds 3 to 6 may be used either individually or in combination as the solvent. The total content of the compounds 3 to 6 in the solvent is preferably 20 wt % or more, more preferably 40 wt % or more, still more preferably 50 wt % or more, and particularly preferably 70 wt % or more.

### 1.4.1. Compounds 3 and 4

The compound 3 is an ether compound shown by the general formula (3), and the compound 4 is an ether compound shown by the general formula (4).

When using the compound 3 and/or the compound 4 as the solvent, the rate of reaction between the organomagnesium salt and the alkoxysilane increases, or precipitation of by-product magnesium salts is promoted. Such a phenomenon is considered to occur due to the polarity and the stereochemical structure of the solvent.

The detailed mechanism is not necessarily clear. For example, when each of the monovalent organic groups represented by R⁶ and R⁷ in the general formula (3) has a carbon atom that is directly bonded to the carbon atom bonded to the oxygen atom of the ether bond, the reaction between the organomagnesium salt and the alkoxysilane can be promoted and the magnesium salt can be promptly precipitated by reacting the organomagnesium salt and the alkoxysilane using the compound 3 as the solvent.

The compound 3 is preferably a compound in which each of the monovalent organic groups represented by R⁶ and R⁷ in the general formula (3) has a carbon atom that is directly bonded to the carbon atom bonded to the oxygen atom of the ether bond. For example, the monovalent organic groups represented by R⁶ and R⁷ are preferably alkyl groups having 1 to 4 carbon atoms, and more preferably a methyl group, an ethyl group, or the like. The monovalent organic groups represented by R⁸ to R¹¹ are preferably alkyl groups having 1 to 4 carbon atoms, and more preferably a methyl group, an ethyl group, or the like.

Examples of the substituent when any of R⁶ to R⁸ or any of R⁹ to R¹¹ form a cyclic structure include alicyclic hydrocarbon groups such as a cyclopentyl group and a cyclohexyl group. The compound 3 is preferably an ether compound having 5 to 8 carbon atoms.

Examples of the compound 3 include the following compounds.

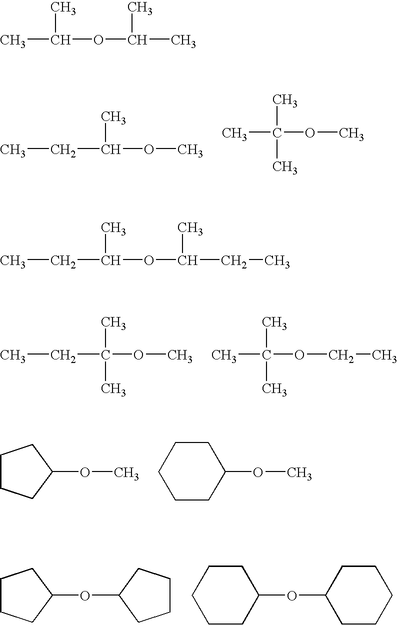

Examples of the aryl group represented by R¹² in the general formula (4) that represents the compound 4 include a phenyl group and the like. Examples of the monovalent organic groups represented by R¹³ to R¹⁵ in the general formula (4) include alkyl groups having 1 to 4 carbon atoms such as a methyl group and an ethyl group.

The monovalent organic groups represented by R¹³ to R¹⁵ in the general formula (4) are preferably hydrogen atoms in order to decrease the boiling point and facilitate fractional distillation.

Examples of the compound 4 include the following compounds.

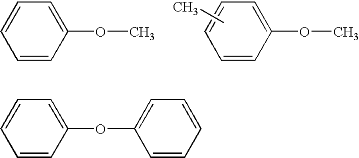

### 1.4.2. Compound 5

The compound 5 is a diether compound shown by the general formula (5).

When using the compound 5 as the solvent, the rate of reaction between an organomagnesium salt and an alkoxysilane increases, or precipitation of by-product magnesium salts is promoted. Such a phenomenon is considered to occur due to the polarity and the stereochemical structure of the solvent.

The detailed mechanism is not necessarily clear. For example, the reaction between the organomagnesium salt and the alkoxysilane can be promoted and the magnesium salt can be promptly precipitated by reacting the organomagnesium salt and the alkoxysilane using the compound 5 as the solvent.

Examples of the alkyl groups having 1 to 6 carbon atoms represented by R¹⁶ and R¹⁸ in the general formula (5) that represents the compound 5 include a methyl group, an ethyl group, an n-propyl group, an isopropyl group, an n-butyl group, an isobutyl group, a tert-butyl group, an n-pentyl group, an isopentyl group, an n-hexyl group, and the like. Among these, a methyl group and an ethyl group are preferable. R¹⁶ and R¹⁷ in the general formula (5) may be the same or different.

Examples of the alkylene group having 1 to 6 carbon atoms represented by R¹⁷ in the general formula (5) include a methylene group, an ethylene group, a trimethylene group, a propylene group, a tetramethylene group, a pentamethylene group, a 2,2-dimethyltrimethylene group, a hexamethylene group, and the like. Among these, an ethylene group and a propylene group are preferable.

Examples of the alkenylene group having 2 to 6 carbon atoms represented by R¹⁷ in the general formula (5) include a vinylene group, a propenylene group, a butadienylene group, and the like.

When R¹⁶ and R¹⁸ form a cyclic structure, —R¹⁶-R¹⁸— may be an alkylene group having 2 to 6 carbon atoms, for example. Examples of the alkylene group having 2 to 6 carbon atoms include the alkylene groups mentioned for R¹⁷. Among these, an ethylene group is preferable.

Example of the compound 5 when R¹⁶ and R¹⁸ form a cyclic structure include 1,4-dioxane, 1,3-dioxane, and the like. Among these, 1,4-dioxane is preferable. The compound 5 preferably has 4 to 8 carbon atoms in order to decrease the boiling point and facilitate fractional distillation.

As the compound 5,1,4-dioxane, 1,2-dimethoxypropane, or 1,2-dimethoxyethane is preferably used.

### 1.4.3. Compound 6

The compound 6 is a hydrocarbon shown by the general formula (6). In the general formula (6) that represents the compound 6 x is preferably an integer from 4 to 20 (more preferably 5 to 10), and y is preferably an integer from 6 to 42 (more preferably 12 to 22).

The compound 6 is preferably liquid at 25° C. The compound 6 may be used either individually or in combination.

In the method of producing a silicon compound according to this embodiment, it is preferable to use a solvent prepared by substituting at least part of a solvent in which the organomagnesium compound (compound 1) and the organosilane compound (compound 2) are dissolved with the hydrocarbon. In this case, the solvent may be substituted with the hydrocarbon by distillation using an evaporation apparatus, for example.

When using a solvent that contains the compound 5, precipitation of by-product magnesium salts can be promoted. Such a phenomenon is considered to occur due to the polarity and the stereochemical structure of the hydrocarbon.

The compound 6 may be at least one hydrocarbon selected from aliphatic hydrocarbons and aromatic hydrocarbons. Examples of these hydrocarbons are given below.

As the aliphatic hydrocarbon, an aliphatic hydrocarbon having 5 to 10 carbon atoms is preferable, for example. Examples of the aliphatic hydrocarbon include aliphatic saturated hydrocarbons such as n-pentane, i-pentane, n-hexane, i-hexane, n-heptane, i-heptane, 2,2,4-trimethylpentane, n-octane, i-octane, cyclohexane, and methylcyclohexane, and aliphatic unsaturated hydrocarbons such as pentene, hexene, heptene, pentadiene, octene, hexadiene, heptadiene, and octadiene.

As the aromatic hydrocarbon, an aromatic hydrocarbon having 6 to 10 carbon atoms is preferable, for example. Examples of the aromatic hydrocarbon include benzene, toluene, xylene, ethylbenzene, trimethylbenzene, methylethylbenzene, n-propylbenzene, i-propylbenzene, diethylbenzene, i-butylbenzene, and the like. These hydrocarbons may be used either individually or in combination.

### 1.5. Silicon Compound (Compound 7)

The silicon compound (compound 7) produced by the method according to this embodiment is shown by the general formula (7). When using the silicon compound (compound 8) shown by the general formula (8) as the organomagnesium compound, a silicon compound (compound 9) shown by the following general formula (9) is obtained.

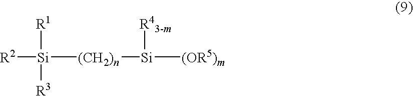

wherein R¹ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group, R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, m represents an integer from 0 to 2, and n represents an integer from 1 to 3.

In the general formula (9), R′ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group. Examples of the alkyl group having 1 to 4 carbon atoms include a methyl group, an ethyl group, an n-propyl group, an isopropyl group, an n-butyl group, an isobutyl group, a tert-butyl group, and the like.

R¹ to R³ are preferably a hydrogen atom, an alkyl group having 1 to 4 carbon atoms, a vinyl group, a phenyl group. Among these, a hydrogen atom, a methyl group, and a vinyl group are particularly preferable.

In the general formula (9), R⁴ individually represent a hydrogen atom, an alkyl group having 1 to 4 carbon atoms, a vinyl group, or a phenyl group. Examples of the alkyl group having 1 to 4 carbon atoms include the alkyl groups mentioned for R¹ to R⁴. R⁴ is preferably a hydrogen atom, a methyl group, or a vinyl group.

In the general formula (9), R⁵ represents an alkyl group having 1 to 4 carbon atoms, an acetyl group, or a phenyl group. Examples of the alkyl group having 1 to 4 carbon atoms include the alkyl groups mentioned for R¹ to R³. R⁵ is preferably a methyl group or an ethyl group.

Examples of the silicon compound shown by the general formula (9) in which n=1 and m=1 include the following compounds.

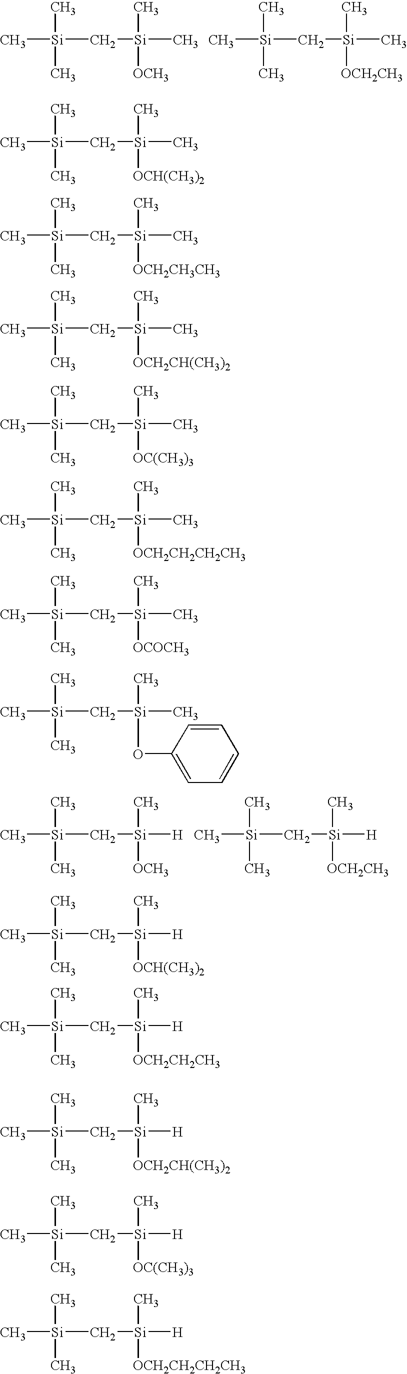

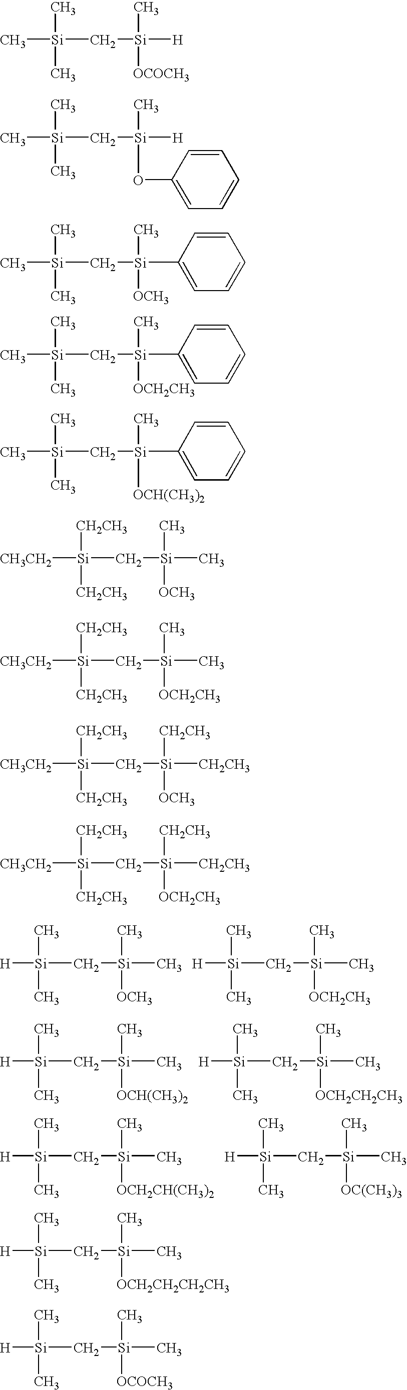

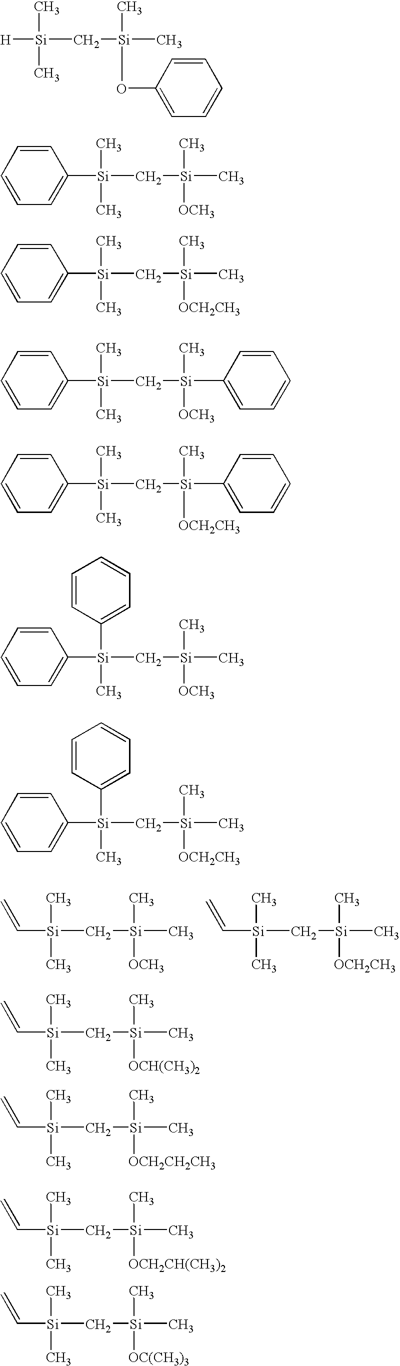

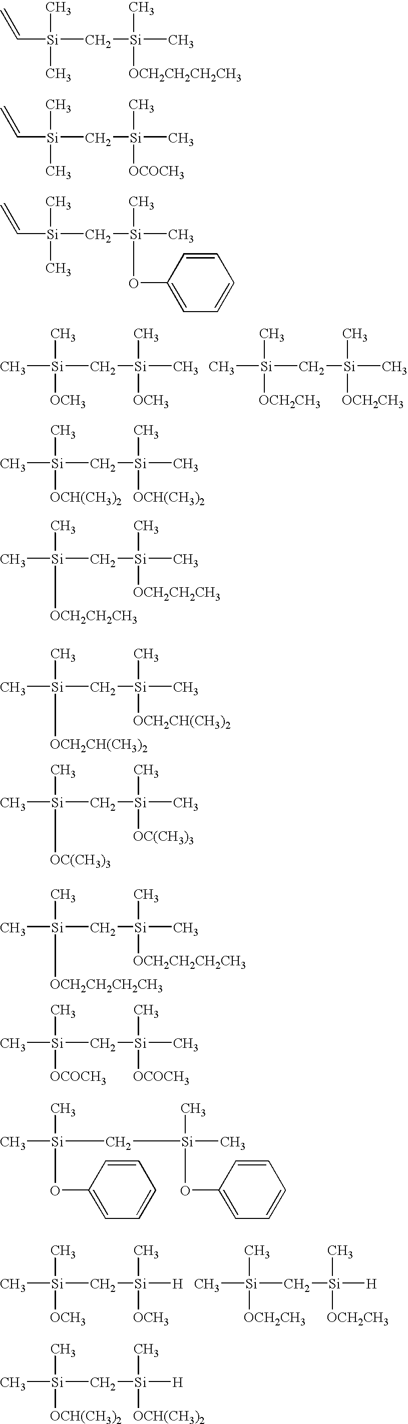

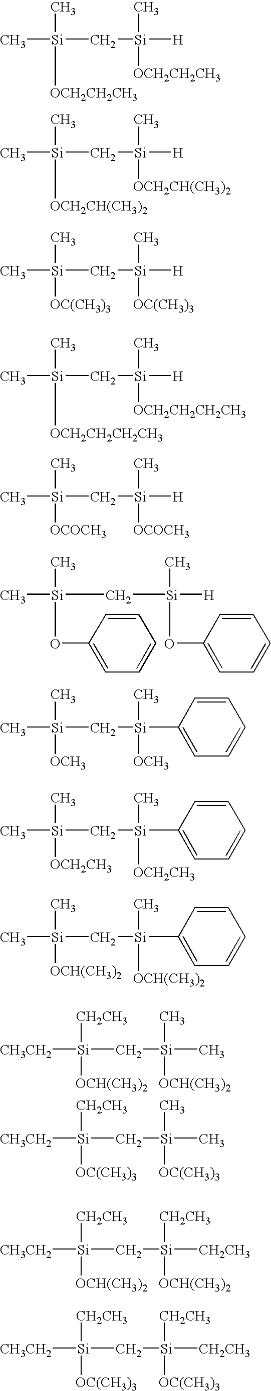

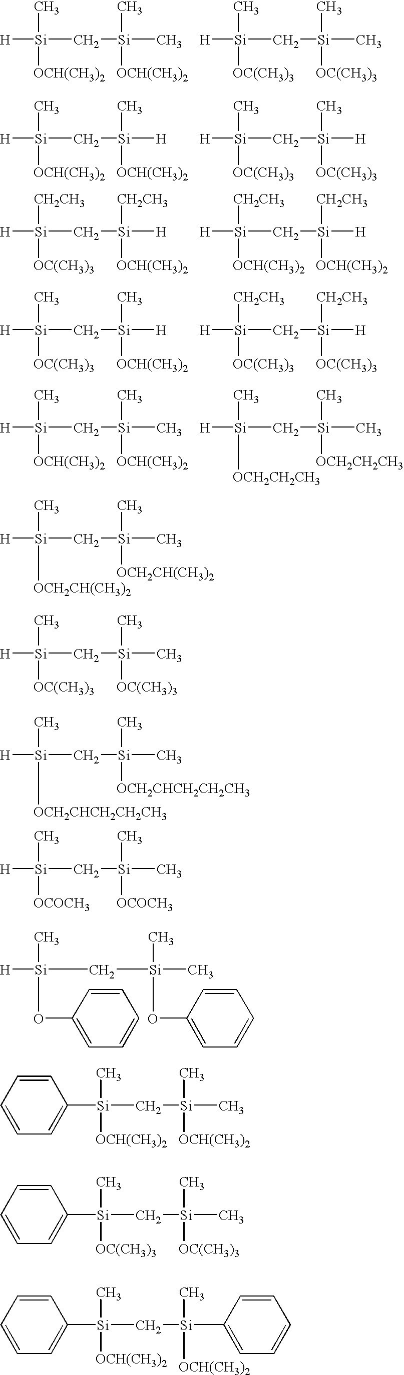

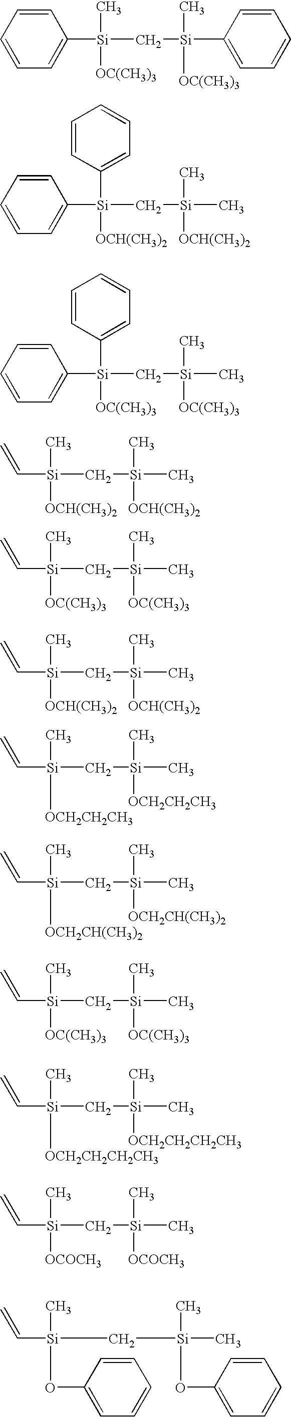

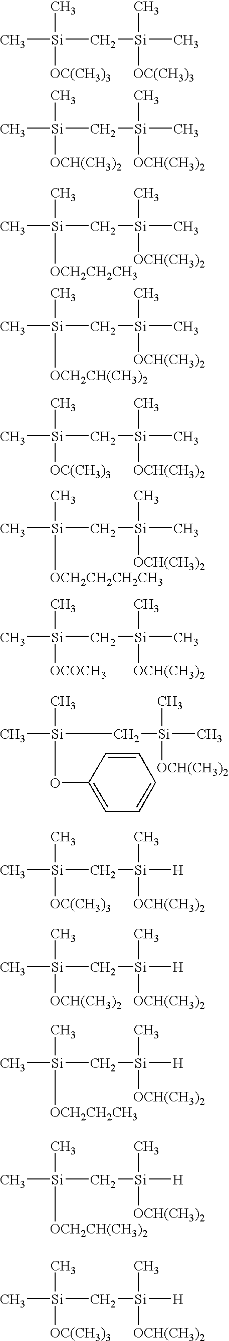

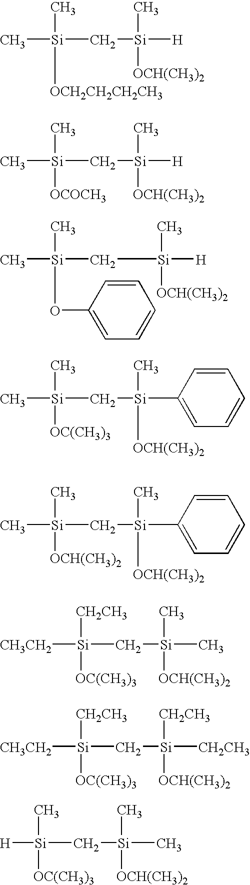

Examples of the silicon compound shown by the general formula (9) in which n=1 and m=2 include the following compounds.

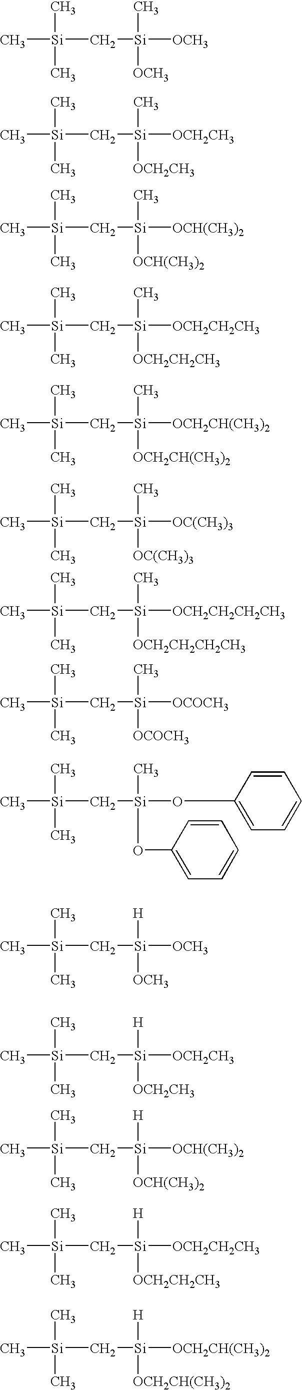

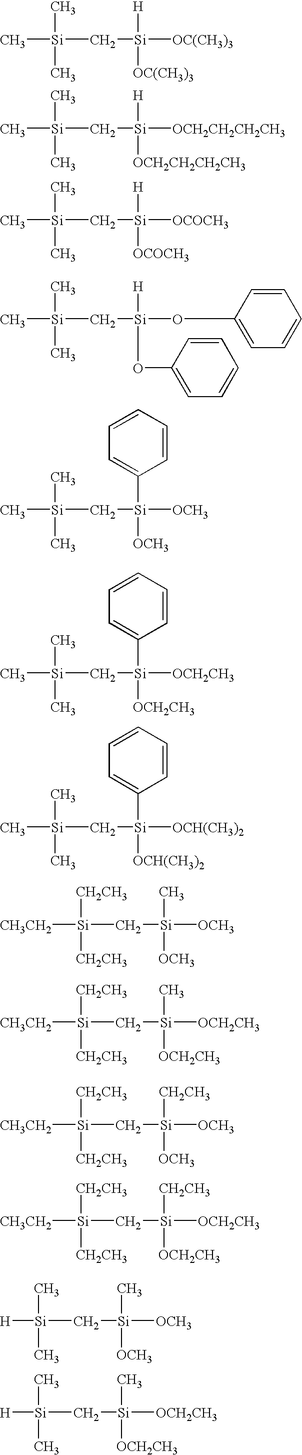

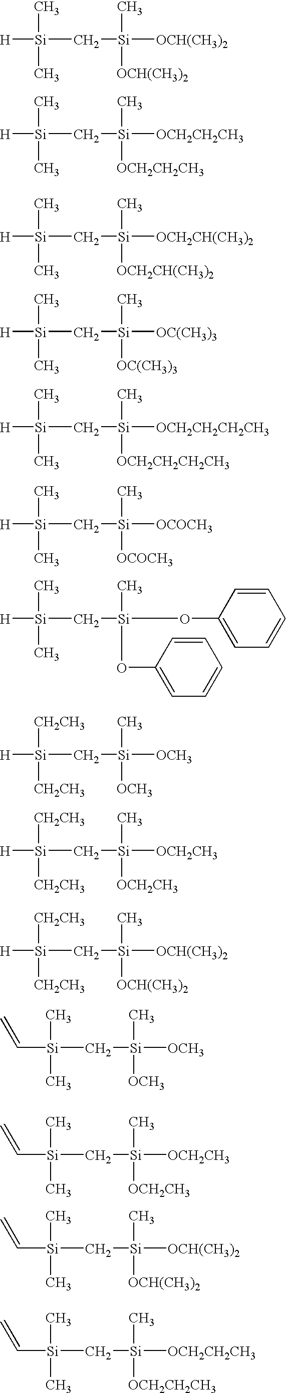

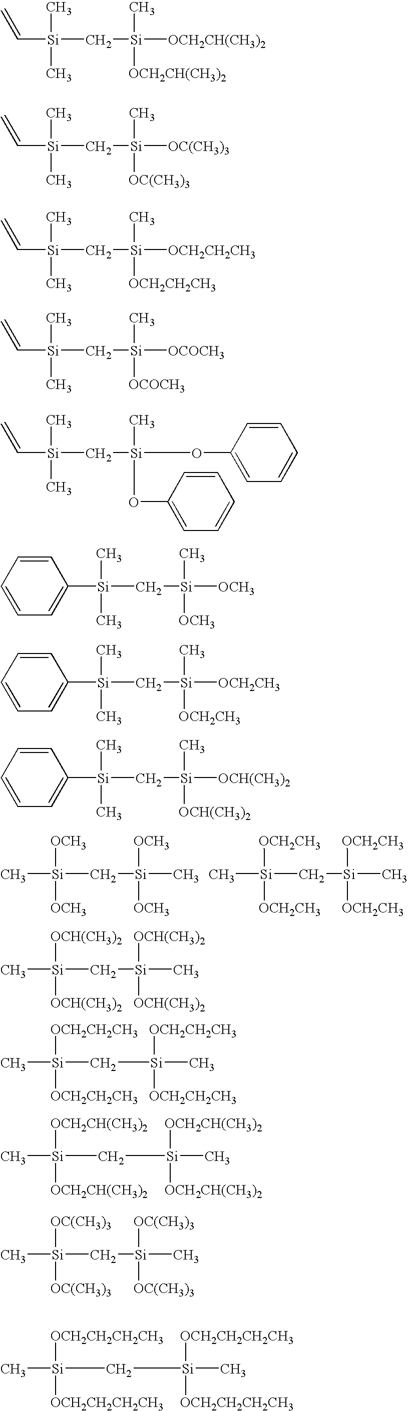

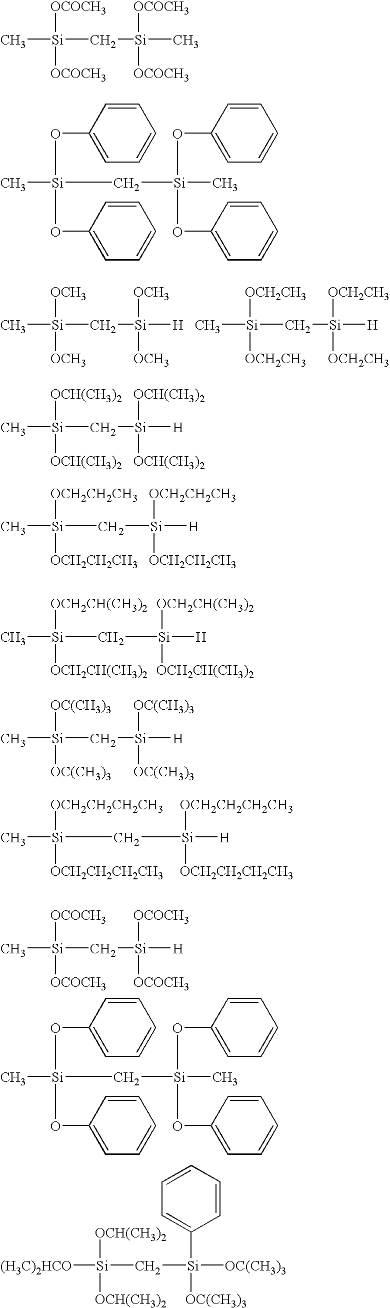

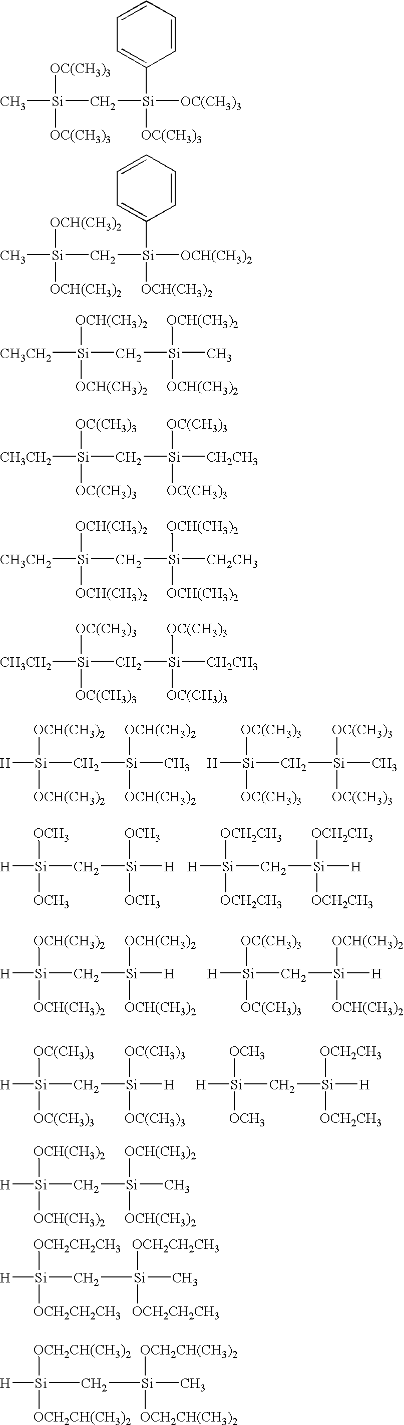

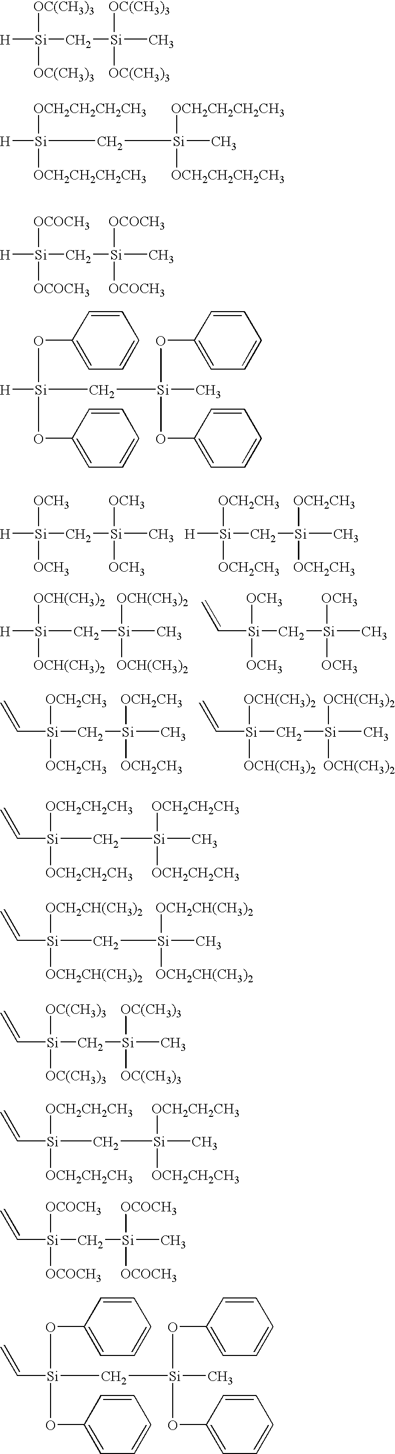

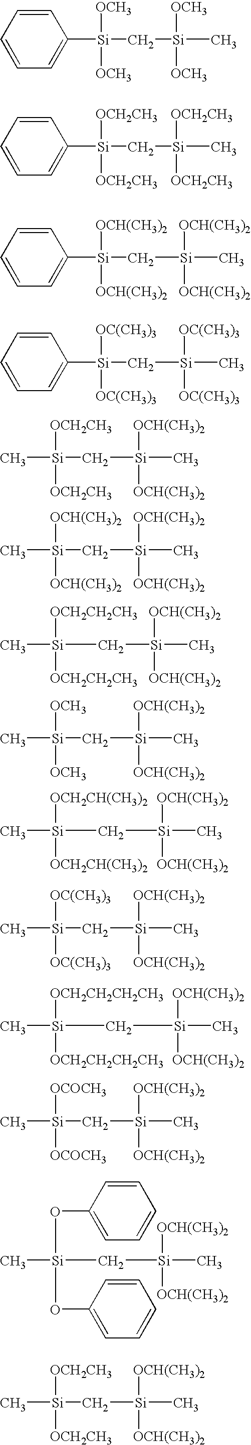

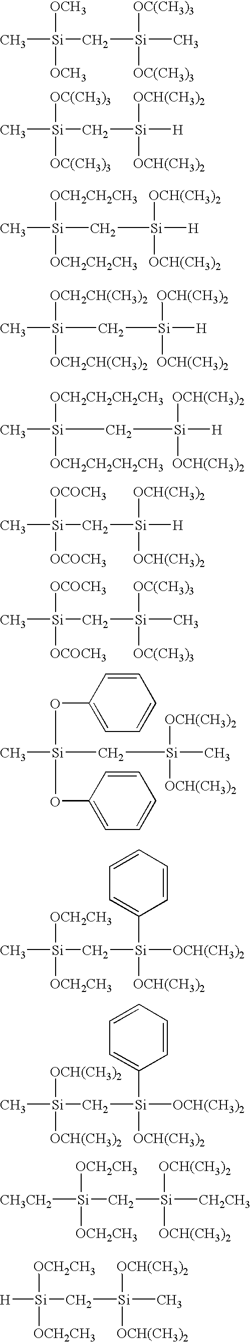

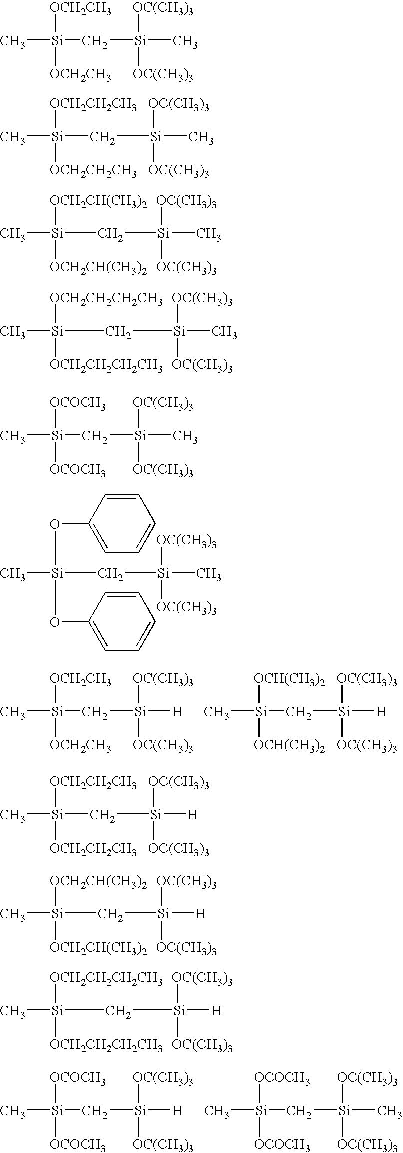

Examples of the silicon compound shown by the general formula (9) in which n=2 and m=2 include the following compounds.

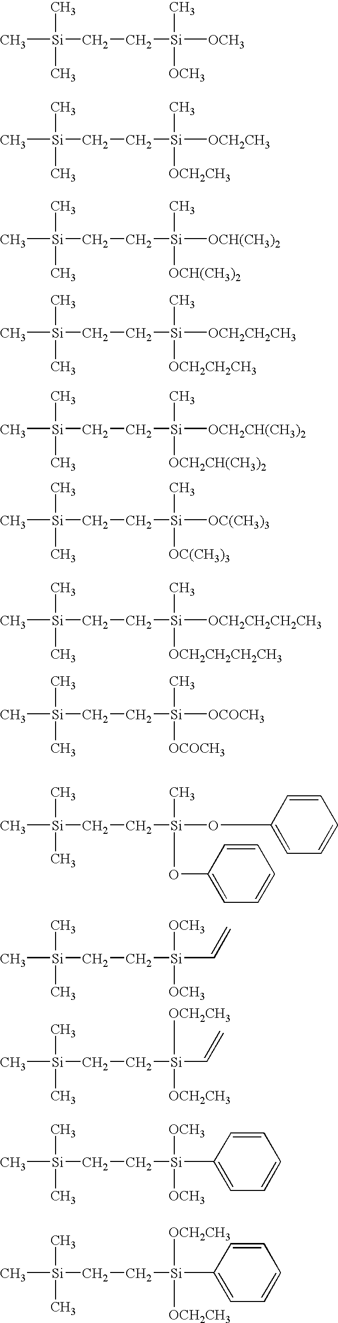

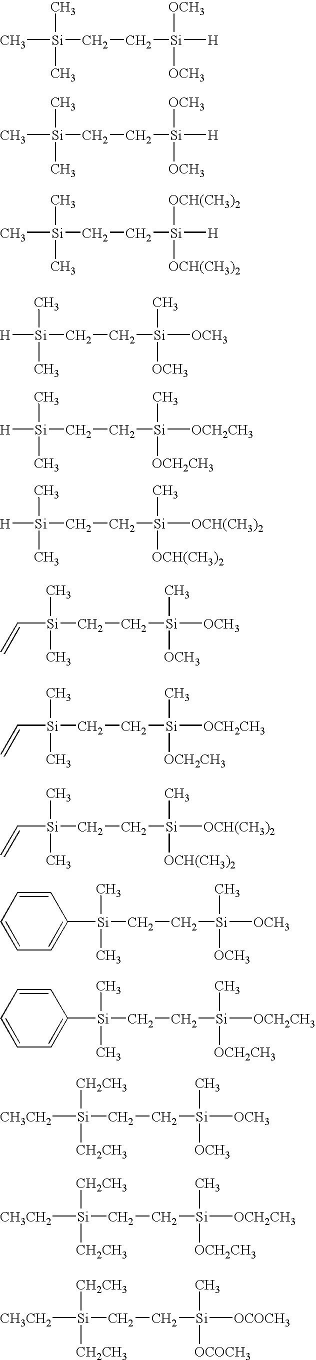

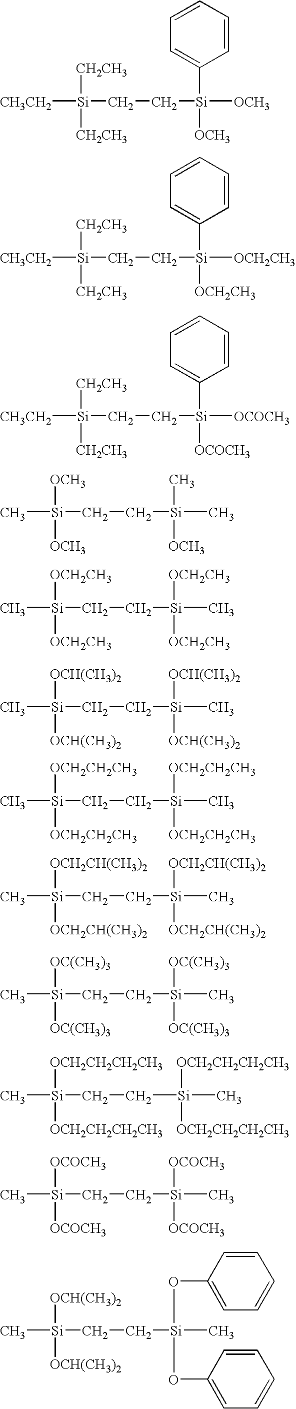

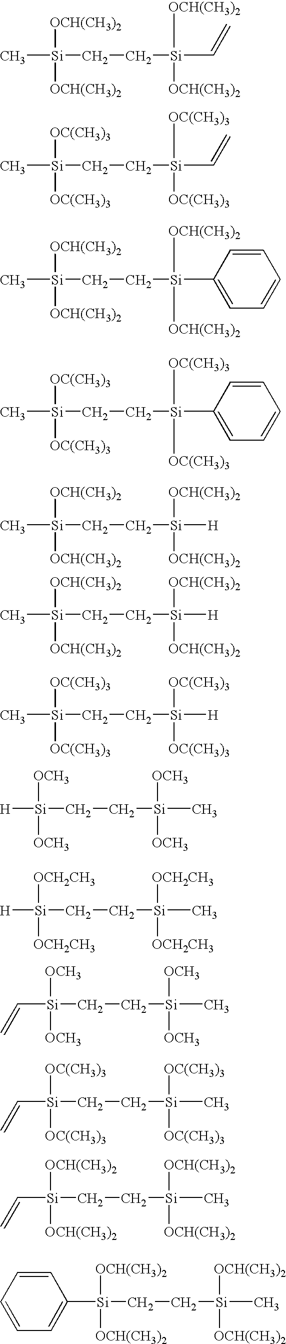

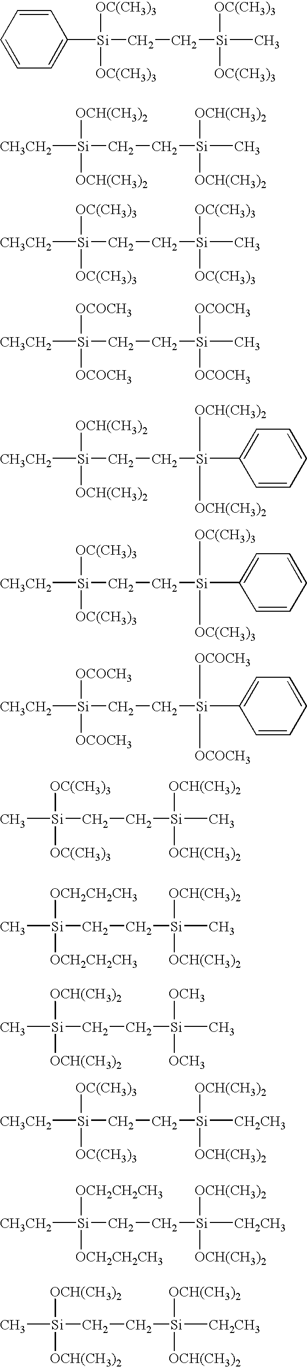

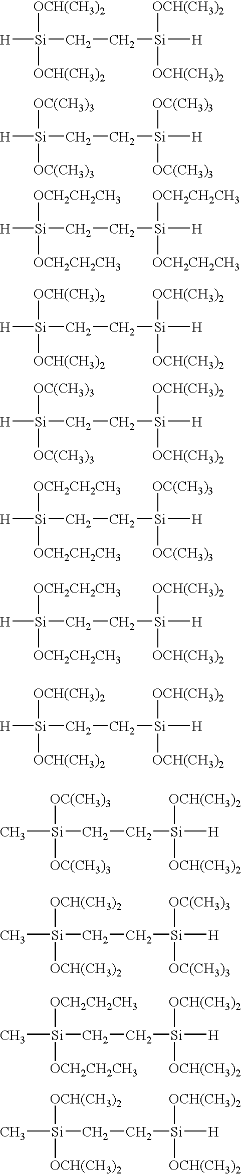

Examples of the silicon compound shown by the general formula (9) in which n=2 and m=1 include the following compounds.

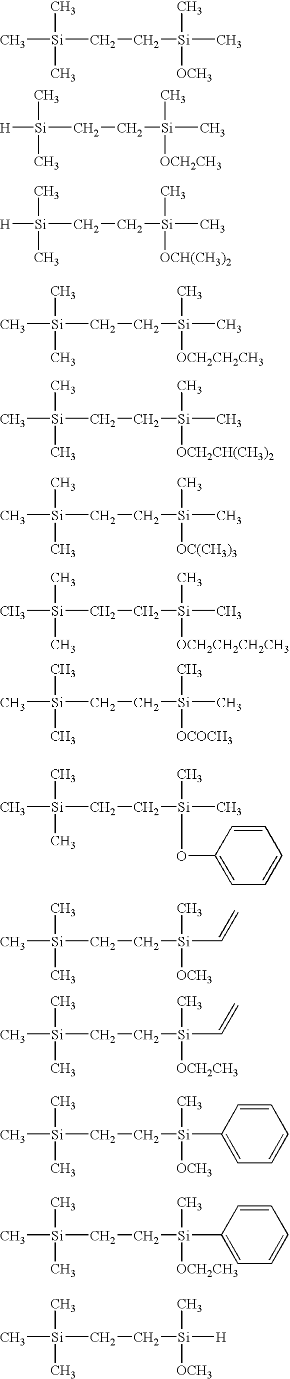

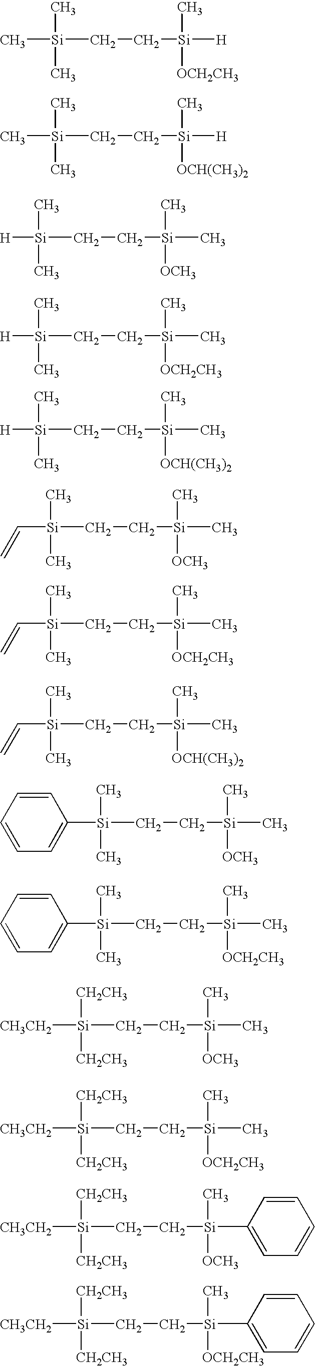

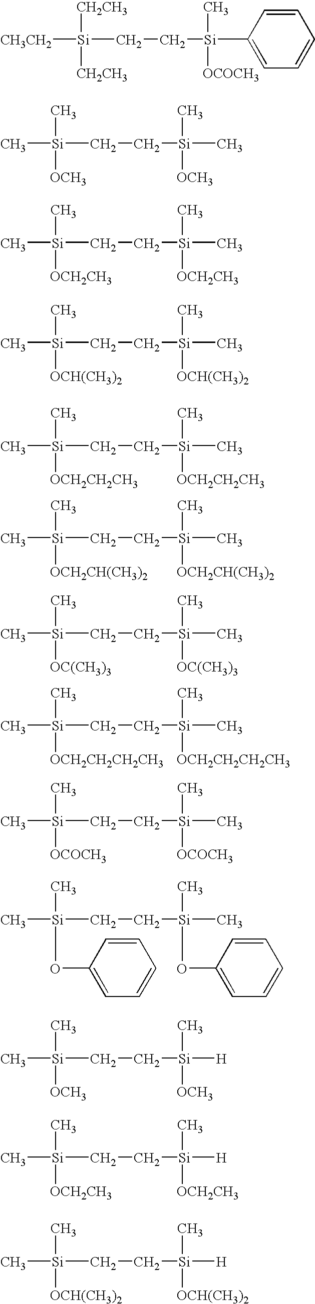

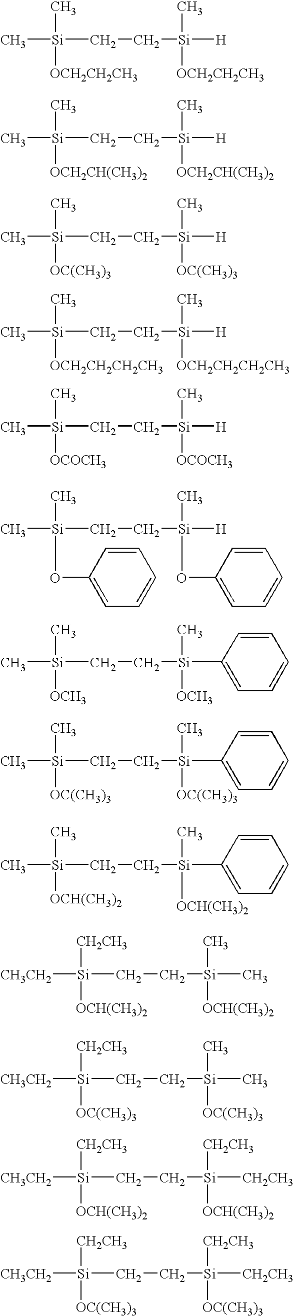

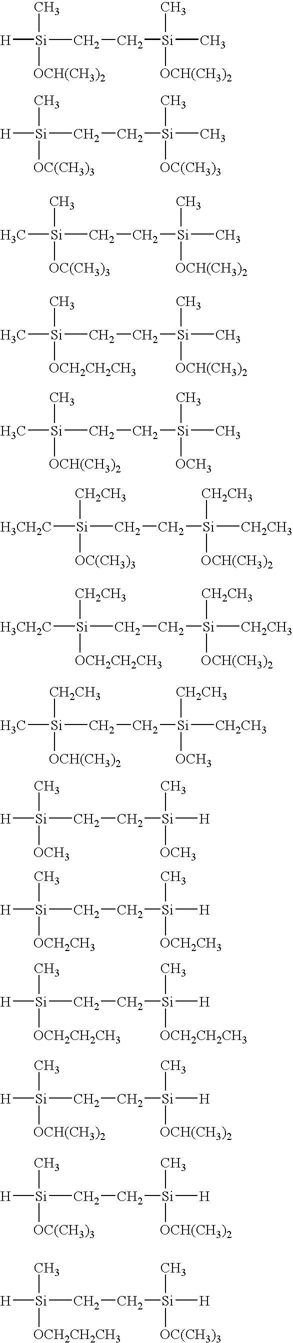

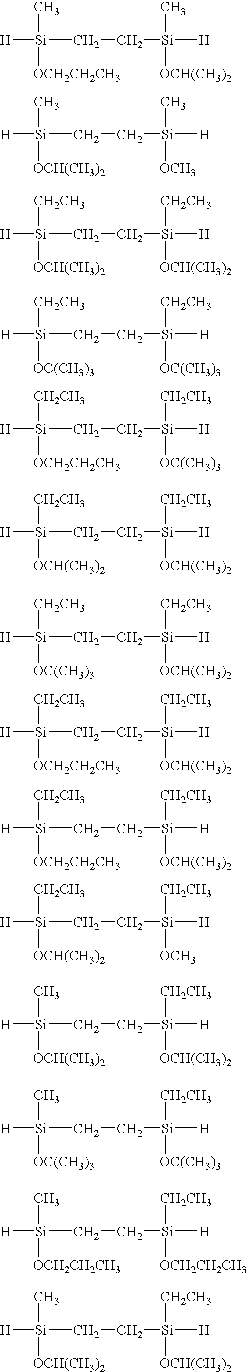

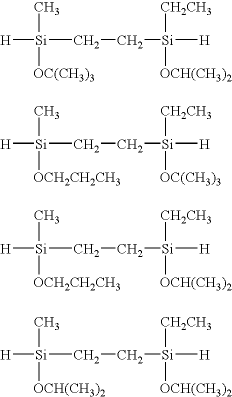

Examples of the silicon compound shown by the general formula (9) in which n=3 and m=1 include the following compounds.

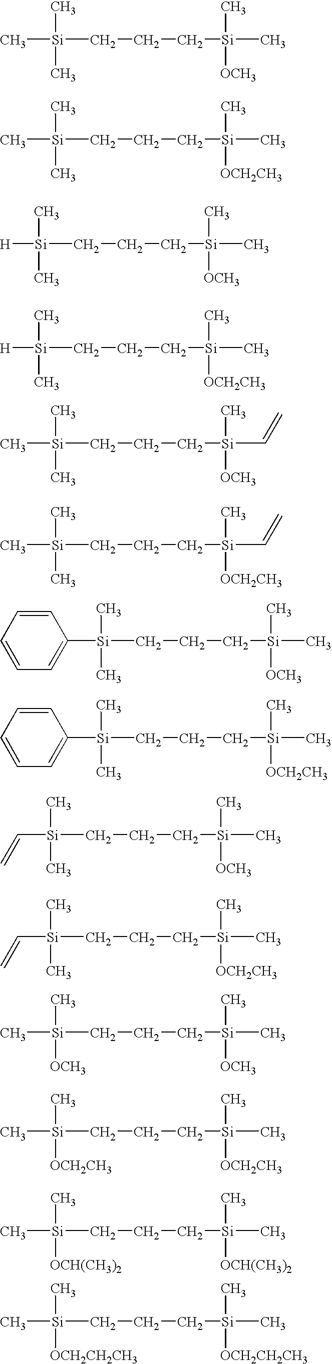

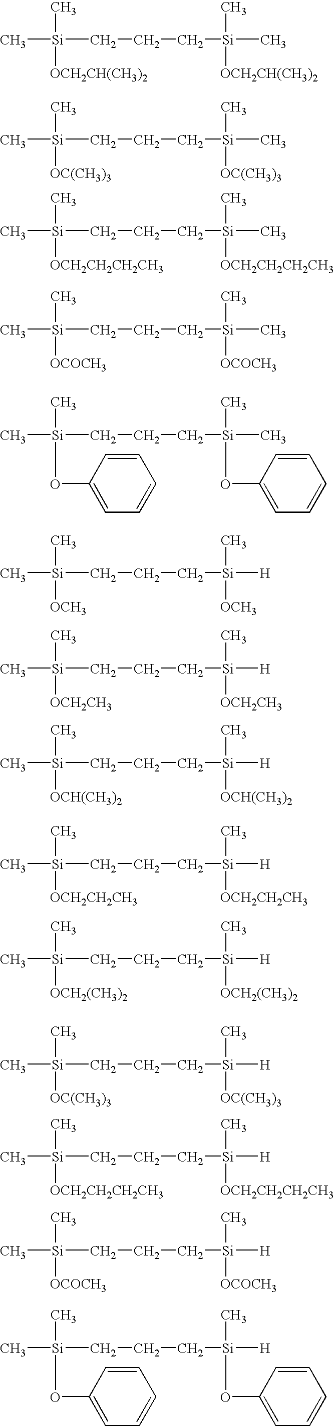

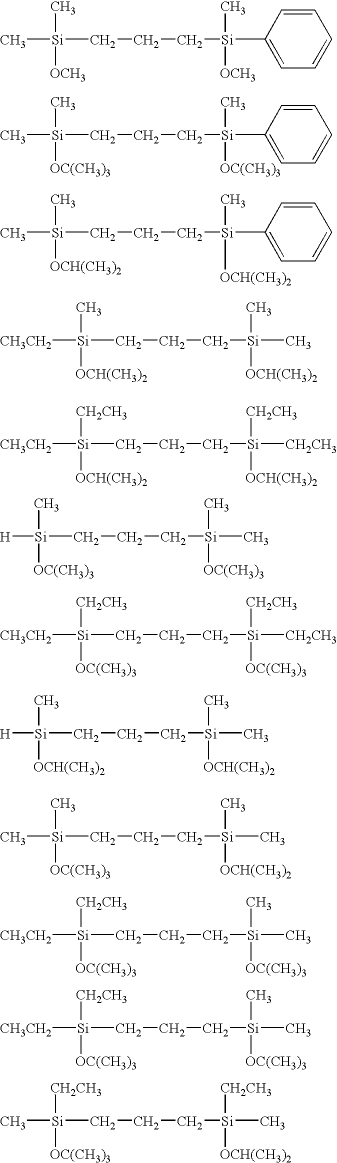

Examples of the silicon compound shown by the general formula (9) in which n=3 and m=2 include the following compounds.

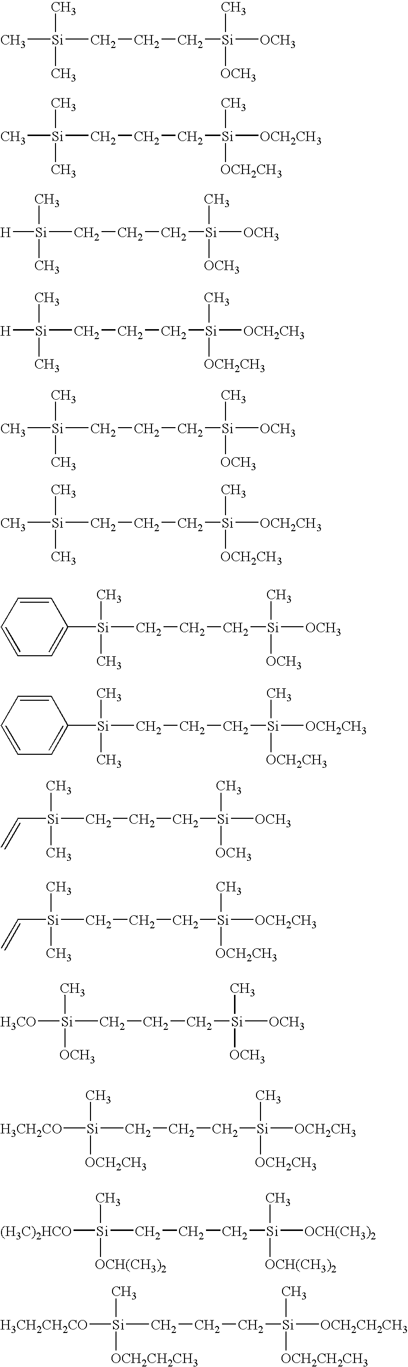

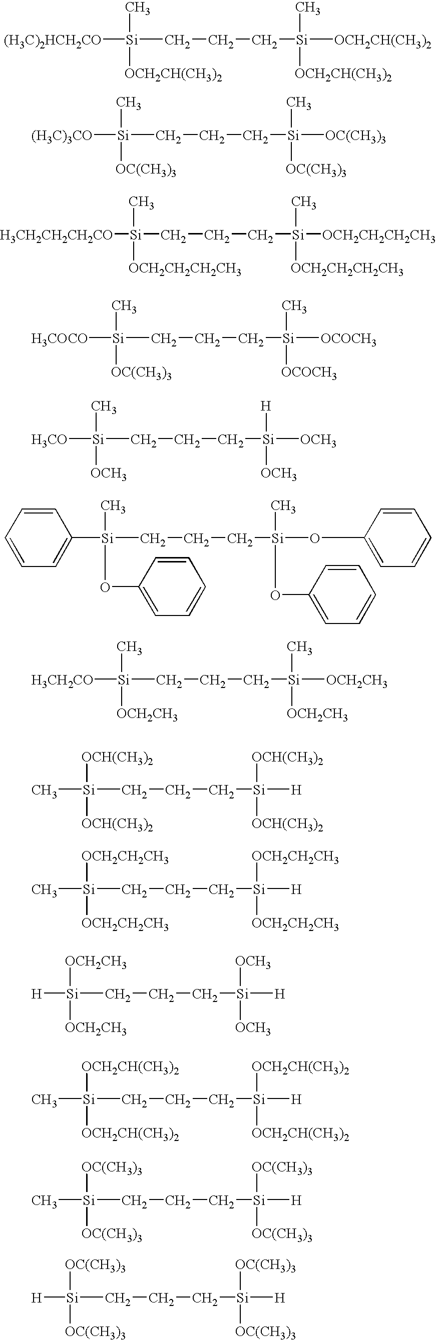

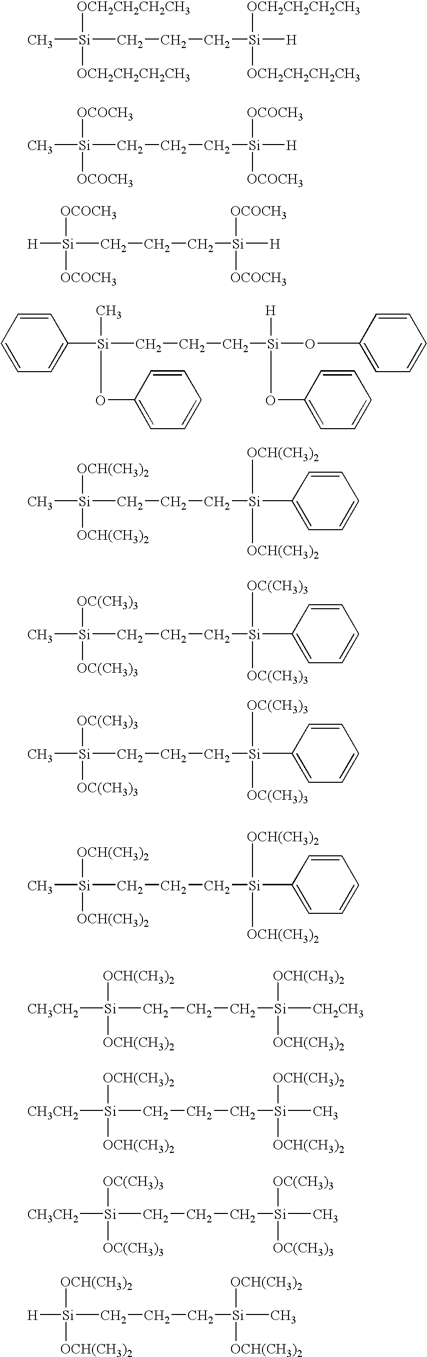

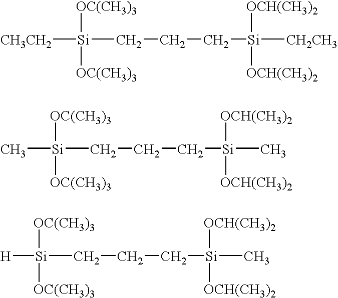

In the silicon compound shown by the general formula (9), it is preferable that the total number of hydrogen atoms included in R¹ to R⁴ be 0 to 2, and more preferably 0 or 1, from the viewpoint of ease of synthesis and purification and handling capability.

The silicon compound according to this embodiment may be used to form an insulating film that includes silicon, carbon, oxygen, and hydrogen. Such an insulating film exhibits high resistance against a hydrofluoric acid-based chemical that is widely used for a washing step during a semiconductor production process (i.e., exhibits high process resistance). When using the silicon compound shown by the general formula (9) as an insulating film material, it is preferable that m be 0 or 1 from the viewpoint of the mechanical strength of the resulting silicon-containing film. When using the silicon compound shown by the general formula (9) as an insulating film material, it is preferable that n be 1 or 2, and more preferably 1.

When using the silicon compound according to this embodiment as an insulating film-forming material, it is preferable that the silicon compound have a content of elements (hereinafter may be referred to as “impurities”) other than silicon, carbon, oxygen, and hydrogen of less than 10 ppb, and a water content of less than 100 ppm. An insulating film that has a low relative dielectric constant and excellent process resistance can be obtained in high yield by forming an insulating film using such an insulating film-forming material.

### 2. Examples and Comparative Examples

The invention is further described below by way of examples. Note that the invention is not limited to the following examples. In the examples and comparative examples, the unit “%” refers to “wt %” unless otherwise indicated.

### 2.1. Evaluation Method

The properties were evaluated as follows.

### 2.1.1. Measurement of Extent of Reaction

A solution was sampled during a reaction, and the ratio of compounds in the solution was determined by gas chromatography (GC) (instrument: “6890N” manufactured by Agilent Technologies, column: “SPB-35” manufactured by Supelco). Each compound was identified by subjecting the sample to GC.

The solution was sampled before heating and when 2 hours, 6 hours, 10 hours, or 16 hours had elapsed after starting heating. The GC measurement was performed immediately after sampling. The measurement results indicate the ration of the alkoxysilane (raw material) to the target product.

2.1.2. Measurement of Degree of Precipitation by-Product Salt

The reaction liquid after synthesis was stirred using a magnetic stirrer at 1000 rpm, and allowed to stand at room temperature. The degree of precipitation of salts after 30 minutes, 1 hour, and 3 hours was determined by calculating the ratio of the height of the supernatant layer to the height of the precipitation layer.

### 2.1.3. Tilt Test

The supernatant of the reaction liquid was separated by a tilt method when 24 hours had elapsed after starting the standing test. Specifically, the supernatant was separated by tilting the container containing the reaction liquid so that only the supernatant was drained. The test results were evaluated as follows.

A: Only the supernatant could be collected.
B: The precipitate flowed when tilting the container (i.e., it was difficult to separate the supernatant by the tilt method).

### 2.2. Synthesis of Silicon Compound

A silicon compound was synthesized using the above method of producing a silicon compound. The details are described below.

### 2.2.1. Example A

### 2.2.1-1. Example A1

A three-necked flask equipped with a cooling condenser and a dropping funnel was dried at 50° C. under reduced pressure, and then charged with nitrogen. After the addition of 20 g of magnesium and 500 ml of diisopropyl ether to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of diisopropyl ether and 89 g of methyltrimethoxysilane was added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 80 g of [(trimethylsilyl)methyl]methyldimethoxysilane. The yield of the product after fractional distillation was 64%, and the purity was 99.2%.

### 2.2.1-2. Example A2

A three-necked flask equipped with a cooling condenser and a dropping funnel was dried at 50° C. under reduced pressure, and then charged with nitrogen. After the addition of 20 g of magnesium and 500 ml of tert-butyl methyl ether to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of tert-butyl methyl ether and 96 g of vinyltrimethoxysilane was added dropwise to the flask over two hours. The mixture was then refluxed with heating at 60° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 83 g of [(trimethylsilyl)methyl]vinyldimethoxysilane. The yield of the product after fractional distillation was 63%, and the purity was 99.4%.

### 2.2.1-3. Example A3

A three-necked flask equipped with a cooling condenser and a dropping funnel was dried at 50° C. under reduced pressure, and then charged with nitrogen. After the addition of 20 g of magnesium and 500 ml of anisole(phenyl methyl ether) to the flask, 25 g of (chloromethyl)dimethylphenylsilane was added to the mixture at room temperature with stirring to obtain (chloromethyl)dimethylphenylsilane as an organomagnesium salt. After continuously stirring the mixture and confirming generation of heat, 83 g of (chloromethyl)dimethylphenylsilane was added to the mixture from the dropping funnel over 30 minutes. After allowing the mixture to cool to room temperature, a mixed liquid of 250 ml of anisole and 107 g of tetramethoxysilane was added dropwise to the flask over two hours. The mixture was then heated at 100° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 105 g of [(dimethylphenylsilyl)methyl]trimethoxysilane. The yield of the product after fractional distillation was 60%, and the purity was 99.2%.

### 2.2.1-4. Example A4

A three-necked flask equipped with a cooling condenser and a dropping funnel was dried at 50° C. under reduced pressure, and then charged with nitrogen. After the addition of 20 g of magnesium and 500 ml of diisopropyl ether to the flask, 25 g of (chloromethyl)methyldiisopropoxysilane was added to the mixture at room temperature with stirring. After continuously stirring the mixture and confirming generation of heat, 115 g of (chloromethyl)methyldiisopropoxysilane was added to the mixture from the dropping funnel over 30 minutes while maintaining the solution temperature at 30° C. or less to obtain (chloromethyl)methyldiisopropoxysilane as an organomagnesium salt. A mixed liquid of 250 ml of diisopropyl ether and 90 g of methyltrimethoxysilane was then added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 155 g of [(methyldiisopropoxysilyl)methyl]methyldimethoxysilane. The yield of the product after fractional distillation was 84%, and the purity was 99.0%.

### 2.2.1-5. Comparative Example A1

A three-necked flask equipped with a cooling condenser and a dropping funnel was dried at 50° C. under reduced pressure, and then charged with nitrogen. After the addition of 20 g of magnesium and 500 ml of THF to the flask, 25 g of (chloromethyl)trimethylsilane was added to the mixture with stirring at room temperature. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of THF and 89 g of methyltrimethoxysilane was added to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 77 g of [(trimethylsilyl)methyl]methyldimethoxysilane. The yield of the product was 62%, and the purity was 99.3%.

### 2.2.1-6. Comparative Example A2

A three-necked flask equipped with a cooling condenser and a dropping funnel was dried at 50° C. under reduced pressure, and then charged with nitrogen. After the addition of 20 g of magnesium and 500 ml of diethyl ether to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of diethyl ether and 89 g of methyltrimethoxysilane was added dropwise to the flask over two hours. The mixture was then refluxed with heating at 40° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 78 g of [trimethylsilyl)methyl]methyldimethoxysilane. The yield of the product after fractional distillation was 63%, and the purity was 99.2%.

### 2.2.1-7. Comparative Example A3

A three-necked flask equipped with a cooling condenser and a dropping funnel was dried at 50° C. under reduced pressure, and then charged with nitrogen. After the addition of 20 g of magnesium and 500 ml of THF to the flask, 25 g of (chloromethyl)trimethylsilane was added to the mixture with stirring at room temperature. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of THF and 89 g of vinyltrimethoxysilane was added to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 81 g of [(trimethylsilyl)methyl]vinyldimethoxysilane. The yield of the product after fractional distillation was 61%, and the purity was 99.1%.

### 2.2.1-8. Comparative Example A4

A three-necked flask equipped with a cooling condenser and a dropping funnel was dried at 50° C. under reduced pressure, and then charged with nitrogen. After the addition of 20 g of magnesium and 500 ml of diethylene glycol diethyl ether to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of diethylene glycol diethyl ether and 89 g of vinyltrimethoxysilane was added to the flask over two hours. The mixture was then heated at 70° C. for 16 hours. A cloudy precipitate (by-product magnesium salts) was observed in the liquid after the reaction.

In this experiment, liquid-phase extraction could not be performed. Since the boiling point of the solvent was almost the same as that of the target product, the isolation operation was not performed.

### 2.2.1-9. Comparative Example A5

A three-necked flask equipped with a cooling condenser and a dropping funnel was dried at 50° C. under reduced pressure, and then charged with nitrogen. After the addition of 20 g of magnesium and 500 ml of THF to the flask, 25 g of (chloromethyl)methyldiisopropoxysilane was added to the mixture with stirring at room temperature. After continuously stirring the mixture and confirming generation of heat, 115 g of (chloromethyl)methyldiisopropoxysilane was added to the mixture from the dropping funnel over 30 minutes while maintaining the solution temperature at 30° C. or less to obtain (chloromethyl)methyldiisopropoxysilane as an organomagnesium salt. A mixed liquid of 250 ml of THF and 90 g of methyltrimethoxysilane was then added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 140 g of [(methyldiisopropoxysilyl)methyl]methyldimethoxysilane. The yield of the product after fractional distillation was 76%, and the purity was 98.7%.

### 2.2.1-10. Evaluation Results

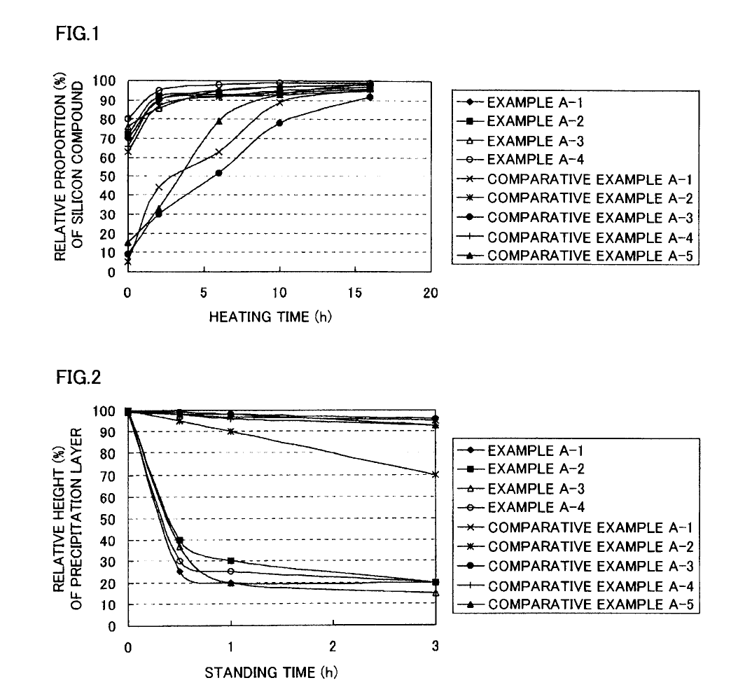

The measurement results for the extent of reaction of the silicon compounds obtained in Examples A1 to A4 are respectively shown in Tables 1 to 4. The measurement results for the extent of reaction of the silicon compounds obtained in Comparative Examples A 1 to A5 are respectively shown in Tables 5 to 9. In Tables 1 to 9, the upper row indicates the relative proportion (%) of the organosilane compound (alkoxysilane) (raw material), and the lower row indicates the relative proportion (%) of the silicon compound (product). FIG. 1 shows the extent of reaction in Examples A1 to A4 and Comparative Examples A1 to A5. In FIG. 1, the horizontal axis indicates the heating time, and the vertical axis indicates the relative proportion of the silicon compound (product). As shown in FIG. 1 and Tables 1 to 9, it was confirmed that the time required for the reaction can be reduced when using the ether solvent such as diisopropyl ether, diethyl ether, tert-butyl methyl ether, anisole, or diethylene glycol diethyl ether as compared with the case of using THF.

TABLE 1

| | | Heating time (h) | | | | |
|---|---|---|---|---|---|---|
| | Compound | 0 | 2 | 6 | 10 | 16 |
| Raw | Methyltrimethoxysilane | 30 | 10 | 5 | 3 | 2 |
| material | | | | | | |
| Product | [(Trimethylsilyl)methyl]methyl- | 70 | 90 | 95 | 97 | 98 |
| | dimethoxysilane | | | | | |

TABLE 2

| | | Heating time (h) | | | | |
|---|---|---|---|---|---|---|
| | Compound | 0 | 2 | 6 | 10 | 16 |
| Raw | Vinyltrimethoxysilane | 28 | 8 | 7 | 6 | 4 |
| material | | | | | | |
| Product | [(Trimethylsilyl)methyl]vinyl- | 72 | 92 | 93 | 94 | 96 |
| | dimethoxysilane | | | | | |

TABLE 3

| | | Heating time (h) | | | | |
|---|---|---|---|---|---|---|
| | Compound | 0 | 2 | 6 | 10 | 16 |
| Raw | Tetramethoxysilane | 24 | 14 | 5 | 3 | 2 |
| material | | | | | | |
| Product | [(Dimethylphenylsilyl)methyl- | 76 | 86 | 95 | 97 | 98 |
| | ]trimethoxysilane | | | | | |

TABLE 4

| | | Heating time (h) | | | | |
|---|---|---|---|---|---|---|
| | Compound | 0 | 2 | 6 | 10 | 16 |
| Raw | Methyltrimethoxysilane | 20 | 5 | 2 | 1 | 1 |
| material | | | | | | |
| Product | [(Methyldiisopropoxysilyl)methyl- | 80 | 95 | 98 | 99 | 99 |
| | ]methyldimethoxysilane | | | | | |

TABLE 5

| | | Heating time (h) | | | | |
|---|---|---|---|---|---|---|
| | Compound | 0 | 2 | 6 | 10 | 16 |
| Raw | Methyltrimethoxysilane | 95 | 56 | 37 | 11 | 4 |
| material | | | | | | |
| Product | [(Trimethylsilyl)methyl]methyl- | 5 | 44 | 63 | 89 | 96 |
| | dimethoxysilane | | | | | |

TABLE 6

| | | Heating time (h) | | | | |
|---|---|---|---|---|---|---|
| | Compound | 0 | 2 | 6 | 10 | 16 |
| Raw | Methyltrimethoxysilane | 35 | 13 | 8 | 5 | 3 |
| material | | | | | | |
| Product | [(Trimethylsilyl)methyl]methyl- | 65 | 87 | 92 | 95 | 97 |
| | dimethoxysilane | | | | | |

TABLE 7

Heating time (h)

| | Compound | 0 | 2 | 6 | 10 | 16 |
|---|---|---|---|---|---|---|
| Raw | Vinyltrimethoxysilane | 91 | 70 | 48 | 22 | 8 |
| material | | | | | | |
| Product | [(Trimethylsilyl)methyl]vinyl- | 9 | 30 | 52 | 78 | 92 |
| | dimethoxysilane | | | | | |

TABLE 8

| | | Heating time (h) | | | | |
|---|---|---|---|---|---|---|
| | Compound | 0 | 2 | 6 | 10 | 16 |
| Raw | Vinyltrimethoxysilane | 34 | 10 | 8 | 7 | 5 |
| material | | | | | | |
| Product | [(Trimethylsilyl)methyl]vinyl- | 66 | 90 | 92 | 93 | 95 |
| | dimethoxysilane | | | | | |

TABLE 9

| | | Heating time (h) | | | | |
|---|---|---|---|---|---|---|
| | Compound | 0 | 2 | 6 | 10 | 16 |
| Raw | Methyltrimethoxysilane | 85 | 67 | 21 | 7 | 3 |
| material | | | | | | |
| Product | [(Methyldiisopropoxysilyl)methyl- | 15 | 33 | 79 | 93 | 97 |
| | ]methyldimethoxysilane | | | | | |

The measurement results for the degree of precipitation of by-product salts and the tilt test results are shown in Table 10. Table 10 shows the ratio (%) of the height of the supernatant layer and the height of the precipitation layer at each standing time and the tilt test evaluation results. The measurement results for the degree of precipitation are shown in FIG. 2. In FIG. 2, the horizontal axis indicates the standing time (h), and the vertical axis indicates the relative height (%) of precipitation layer.

TABLE 10

| | (Height of supernatant layer (%)/ | | | |
|---|---|---|---|---|
| | height of precipitation layer (%)) | | | |
| | 30 minutes | 1 hour | 3 hours | Tilt test |
| Example A1 | 75/25 | 80/20 | 80/20 | A |
| Comparative | 2/98 | 3/97 | 5/95 | B |
| Example A1 | | | | |
| Comparative | 5/95 | 10/90 | 30/70 | B |
| Example A2 | | | | |
| Example A2 | 60/40 | 70/30 | 80/20 | A |
| Comparative | 1/99 | 2/98 | 4/96 | B |
| Example A3 | | | | |
| Comparative | 2/98 | 4/96 | 7/93 | B |
| Example A4 | | | | |
| Example A3 | 67/37 | 80/20 | 85/15 | A |
| Example A4 | 70/30 | 75/25 | 80/20 | A |
| Comparative | 1/99 | 2/98 | 4/96 | B |
| Example A5 | | | | |

As shown in FIG. 2 and Table 10, it was confirmed that the precipitation rate of the magnesium salts was high in Examples A 1 to A4 so that the salts and the supernatant can be easily separated (i.e., the supernatant can be efficiently collected). Therefore, it was confirmed that the synthesis time can be reduced and the synthesis process and the post-synthesis process can be easily performed by utilizing a solvent containing the compound 3 (e.g., diisopropyl ether or tert-butyl methyl ether) and the compound 4 (e.g., anisole) when producing the silicon compound (compound 1).

### 2.2.2. Example B

### 2.2.2-1. Example B1

A three-necked flask equipped with a cooling condenser and a dropping funnel was dried at 50° C. under reduced pressure, and then charged with nitrogen. After the addition of 20 g of magnesium and 500 ml of dimethoxyethane to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of dimethoxyethane and 89 g of methyltrimethoxysilane was added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 80 g of [(trimethylsilyl)methyl]methyldimethoxysilane. The yield of the product after fractional distillation was 67%, and the purity was 99.5%.

### 2.2.2-2. Example B2

A three-necked flask equipped with a cooling condenser and a dropping funnel was dried at 50° C. under reduced pressure, and then charged with nitrogen. After the addition of 20 g of magnesium and 500 ml of 1,4-dioxane to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of 1,4-dioxane and 89 g of vinyltrimethoxysilane was added to the flask over two hours. The mixture was then refluxed with heating at 60° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 83 g of [(trimethylsilyl)methyl]vinyldimethoxysilane. The yield of the product after fractional distillation was 69%, and the purity was 99.3%.

### 2.2.2-3. Example B3

A three-necked flask equipped with a cooling condenser and a dropping funnel was dried at 50° C. under reduced pressure, and then charged with nitrogen. After the addition of 20 g of magnesium and 500 ml of dimethoxyethane to the flask, 25 g of (chloromethyl)methyldiisopropoxysilane was added to the mixture at room temperature with stirring. After continuously stirring the mixture and confirming generation of heat, 115 g of (chloromethyl)methyldiisopropoxysilane was added to the mixture from the dropping funnel over 30 minutes while maintaining the solution temperature at 30° C. or less to obtain (chloromethyl)methyldiisopropoxysilane as an organomagnesium salt. A mixed liquid of 250 ml of dimethoxyethane and 90 g of methyltrimethoxysilane was then added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 152 g of [(methyldiisopropoxysilyl)methyl]methyldimethoxysilane. The yield of the product after fractional distillation was 82%, and the purity was 99.4%.

### 2.2.2-4. Comparative Example B1

A three-necked flask equipped with a cooling condenser and a dropping funnel was dried at 50° C. under reduced pressure, and then charged with nitrogen. After the addition of 20 g of magnesium and 500 ml of THF to the flask, 25 g of (chloromethyl)trimethylsilane was added to the mixture with stirring at room temperature. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of THF and 89 g of methyltrimethoxysilane was added to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 77 g of [(trimethylsilyl)methyl]methyldimethoxysilane. The yield of the product after fractional distillation was 62%, and the purity was 99.3%.

### 2.2.2-5. Comparative Example B2

A three-necked flask equipped with a cooling condenser and a dropping funnel was dried at 50° C. under reduced pressure, and then charged with nitrogen. After the addition of 20 g of magnesium and 500 ml of THF to the flask, 25 g of (chloromethyl)methyldiisopropoxysilane was added to the mixture at room temperature with stirring. After continuously stirring the mixture and confirming generation of heat, 115 g of (chloromethyl)methyldiisopropoxysilane was added to the mixture from the dropping funnel over 30 minutes while maintaining the solution temperature at 30° C. or less to obtain (chloromethyl)methyldiisopropoxysilane as an organomagnesium salt. A mixed liquid of 250 ml of THF and 90 g of methyltrimethoxysilane was then added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 140 g of [(methyldiisopropoxysilyl)methyl]methyldimethoxysilane. The yield of the product after fractional distillation was 76%, and the purity was 98.7%.

### 2.2.2-6. Evaluation Results

The measurement results for the extent of reaction of the silicon compounds obtained in Examples B1 to B3 are respectively shown in Tables 11 to 13. The measurement results for the extent of reaction of the silicon compounds obtained in Comparative Examples B1 and B2 are respectively shown in Tables 14 and 15. In Tables 11 to 15, the upper row indicates the relative proportion (%) of the organosilane compound (alkoxysilane) (raw material), and the lower row indicates the relative proportion (%) of the silicon compound (product). As shown in Tables 11 to 15, it was confirmed that the time required for the reaction can be reduced when producing the compound 7 using a solvent containing the compound 5 as compared with the case of using THF.

TABLE 11

| | | Heating time (h) | | | | |
|---|---|---|---|---|---|---|
| | Compound | 0 | 2 | 6 | 10 | 16 |
| Raw | Methyltrimethoxysilane | 32 | 15 | 8 | 5 | 2 |
| material | | | | | | |
| Product | [(Trimethylsilyl)methyl]methyl- | 68 | 85 | 92 | 95 | 98 |
| | dimethoxysilane | | | | | |

TABLE 12

| | | Heating time (h) | | | | |
|---|---|---|---|---|---|---|
| | Compound | 0 | 2 | 6 | 10 | 16 |
| Raw | Vinyltrimethoxysilane | 35 | 12 | 9 | 6 | 4 |
| material | | | | | | |
| Product | [(Trimethylsilyl)methyl]vinyl- | 65 | 88 | 91 | 94 | 96 |
| | dimethoxysilane | | | | | |

TABLE 13

| | | Heating time (h) | | | | |
|---|---|---|---|---|---|---|
| | Compound | 0 | 2 | 6 | 10 | 16 |
| Raw | Methyltrimethoxysilane | 18 | 4 | 2 | 1 | 1 |
| material | | | | | | |
| Product | [(Methyldiisopropoxysilyl)methyl]- | 82 | 96 | 98 | 99 | 99 |
| | methyldimethoxysilane | | | | | |

TABLE 14

| | | Heating time (h) | | | | |
|---|---|---|---|---|---|---|
| | Compound | 0 | 2 | 6 | 10 | 16 |
| Raw | Methyltrimethoxysilane | 95 | 56 | 37 | 11 | 4 |
| material | | | | | | |
| Product | [(Trimethylsilyl)methyl]methyl- | 5 | 44 | 63 | 89 | 96 |
| | dimethoxysilane | | | | | |

TABLE 15

| | | Heating time (h) | | | | |
|---|---|---|---|---|---|---|
| | Compound | 0 | 2 | 6 | 10 | 16 |
| Raw | Methyltrimethoxysilane | 85 | 67 | 21 | 7 | 3 |
| material | | | | | | |
| Product | [(Methyldiisopropoxysilyl)methyl]- | 15 | 33 | 79 | 93 | 97 |
| | methyldimethoxysilane | | | | | |

The measurement results for the degree of precipitation of by-product salts and the tilt test results are shown in Table 16. Table 16 shows the ratio (%) of the height of the supernatant layer and the height of the precipitation layer at each standing time and the tilt test evaluation results.

TABLE 16

| | (Height of supernatant layer (%)/ | | | |
|---|---|---|---|---|
| | height of precipitation layer (%)) | | | |
| | 30 minutes | 1 hour | 3 hours | Tilt test |
| Example B1 | 60/40 | 70/30 | 80/20 | A |
| Example B2 | 75/25 | 80/20 | 80/20 | A |
| Comparative | 1/99 | 2/98 | 4/96 | B |
| Example B1 | | | | |
| Example B3 | 75/25 | 80/20 | 80/20 | A |
| Comparative | 1/99 | 2/98 | 4/96 | B |
| Example B2 | | | | |

As shown in Table 16, since the solvent containing the compound 5 was used in Examples B1 to B3, the precipitation rate of the magnesium salts was high as compared with Comparative Examples B1 and B2 in which THF was used as the solvent. Specifically, it was confirmed that the salts and the supernatant can be easily separated (i.e., the supernatant can be efficiently collected) according to Examples B1 to B3. Therefore, it was confirmed that the synthesis time can be reduced and the synthesis process and the post-synthesis process can be easily performed by utilizing the compound 3 as a solvent when producing the compound 7.

### 2.2.3. Example C

### 2.2.3-1. Example C1

A three-necked flask equipped with a cooling condenser and a dropping funnel was dried at 50° C. under reduced pressure, and then charged with nitrogen. After the addition of 20 g of magnesium and 500 ml of tetrahydrofuran to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, 1000 ml of toluene was added to the mixture. The solvent was then evaporated using an evaporator until the total amount of the reaction liquid was 450 g (solvent replacement). A mixed liquid of 150 ml of toluene and 89 g of methyltrimethoxysilane was then added dropwise to the flask containing the concentrated reaction liquid over two hours. The mixture was then refluxed with heating at 60° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 80 g of [(trimethylsilyl)methyl]methyldimethoxysilane. The yield of the product after fractional distillation was 67%, and the purity was 99.5%.

### 2.2.3-2. Example C2

A three-necked flask equipped with a cooling condenser and a dropping funnel was dried at 50° C. under reduced pressure, and then charged with nitrogen. After the addition of 20 g of magnesium and 500 ml of tetrahydrofuran to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, 1000 ml of heptane was added to the mixture. The solvent was then evaporated using an evaporator until the total amount of the reaction liquid was 450 g (solvent replacement). A mixed liquid of 150 ml of heptane and 96 g of vinyltrimethoxysilane was then added dropwise to the flask containing the concentrated reaction liquid over two hours. The mixture was then refluxed with heating at 60° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 83 g of [(trimethylsilyl)methyl]vinyldimethoxysilane.

The yield of the product after fractional distillation was 65%, and the purity was 99.5%.

### 2.2.3-3. Example C3

A three-necked flask equipped with a cooling condenser and a dropping funnel was dried at 50° C. under reduced pressure, and then charged with nitrogen. After the addition of 20 g of magnesium and 500 ml of tetrahydrofuran to the flask, 25 g of (chloromethyl)methyldiisopropoxysilane was added to the mixture at room temperature with stirring. After continuously stirring the mixture and confirming generation of heat, 115 g of (chloromethyl)methyldiisopropoxysilane was added to the mixture from the dropping funnel over 30 minutes while maintaining the solution temperature at 30° C. or less to obtain (chloromethyl)methyldiisopropoxysilane as an organomagnesium salt. After allowing the mixture to cool to room temperature, 1000 ml of toluene was added to the mixture. The solvent was then evaporated using an evaporator until the total amount of the reaction liquid was 450 g (solvent replacement). A mixed liquid of 150 ml of toluene and 90 g of methyltrimethoxysilane was then added dropwise to the flask containing the concentrated reaction liquid over two hours. The mixture was then refluxed with heating at 60° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 150 g of [(methyldiisopropoxysilyl)methyl]methyldimethoxysilane. The yield of the product after fractional distillation was 81%, and the purity was 99.1%.

### 2.2.3-4. Comparative Example C1

A three-necked flask equipped with a cooling condenser and a dropping funnel was dried at 50° C. under reduced pressure, and then charged with nitrogen. After the addition of 20 g of magnesium and 500 ml of tetrahydrofuran to the flask, 25 g of (chloromethyl)trimethylsilane was added to the mixture at room temperature with stirring. After continuously stirring the mixture and confirming generation of heat, 55 g of (chloromethyl)trimethylsilane was added to the mixture from the dropping funnel over 30 minutes to obtain (chloromethyl)trimethylsilane as an organomagnesium salt. After allowing the mixture to cool to room temperature, a mixed liquid of 250 ml of tetrahydrofuran and 89 g of methyltrimethoxysilane was added to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 77 g of [(trimethylsilyl)methyl]methyldimethoxysilane. The yield of the product after fractional distillation was 62%, and the purity was 99.3%.

### 2.2.3-5. Comparative Example C2

A three-necked flask equipped with a cooling condenser and a dropping funnel was dried at 50° C. under reduced pressure, and then charged with nitrogen. After the addition of 20 g of magnesium and 500 ml of THF to the flask, 25 g of (chloromethyl)methyldiisopropoxysilane was added to the mixture at room temperature with stirring. After continuously stirring the mixture and confirming generation of heat, 115 g of (chloromethyl)methyldiisopropoxysilane was added to the mixture from the dropping funnel over 30 minutes while maintaining the solution temperature at 30° C. or less to obtain (chloromethyl)methyldiisopropoxysilane as an organomagnesium salt. A mixed liquid of 250 ml of THF and 90 g of methyltrimethoxysilane was then added dropwise to the flask over two hours. The mixture was then refluxed with heating at 70° C. for 16 hours. A cloudy precipitate (by-product magnesium salts) was observed in the liquid after the reaction. The magnesium salts produced and unreacted magnesium were filtered out, and the filtrate was subjected to fractional distillation to obtain 140 g of [(methyldiisopropoxysilyl)methyl]methyldimethoxysilane. The yield of the product after fractional distillation was 76%, and the purity was 98.7%.

### 2.2.3-6. Evaluation Results

The measurement results for the degree of precipitation of by-product salts and the tilt test results are shown in Table 17. Table 17 shows the ratio (%) of the height of the supernatant layer and the height of the precipitation layer at each standing time and the tilt test evaluation results.

TABLE 17

| | (Height of supernatant layer (%)/ | | | |
|---|---|---|---|---|
| | height of precipitation layer (%)) | | | |
| | 30 minutes | 1 hour | 3 hours | Tilt test |
| Example C1 | 60/40 | 70/30 | 80/20 | A |
| Example C2 | 80/20 | 80/20 | 80/20 | A |
| Comparative | 1/99 | 2/98 | 4/96 | B |
| Example C1 | | | | |
| Example C3 | 85/15 | 90/10 | 90/10 | A |
| Comparative | 1/99 | 2/98 | 4/96 | B |
| Example C2 | | | | |

As shown in Table 17, since the solvent containing the compound 6 was used in Examples C1 to C3, the precipitation rate of the magnesium salts was high as compared with Comparative Examples C1 and C2 in which tetrahydrofuran was used as the solvent. Specifically, it was confirmed that the salts and the supernatant can be easily separated (i.e., the supernatant can be efficiently collected) according to Examples C1 to C3. Therefore, it was confirmed that the post-synthesis process can be easily performed by utilizing a solvent containing the compound 6 when producing the compound 7.

1. A method of producing a silicon compound shown by the following general formula (7), the method comprising reacting an organomagnesium compound shown by the following general formula (1) with an organosilane compound shown by the following general formula (2) in a solvent that contains at least one compound selected from a compound shown by the following general formula (3), a compound shown by the following general formula (4), a compound shown by the following general formula (5), and a compound shown by the following general formula (6),
RMgX (1)
wherein R represents a monovalent organic group, and X represents a halogen atom,
R⁴ₘSi(OR⁵)₄₋ₘ (2)
wherein R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, and m represents an integer from 0 to 2, 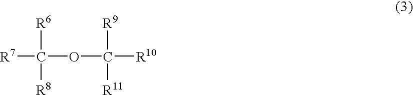
wherein R⁶ and R⁷ individually represent a monovalent organic group, and R⁸ to R¹¹ individually represent a hydrogen atom or a monovalent organic group, provided that any of R⁶ to R⁸ or any of R⁹ to R¹¹ may form a cyclic structure, 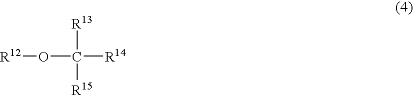
wherein R¹² represents an aryl group, and R¹³ to R¹⁵ individually represent a hydrogen atom or a monovalent organic group, provided that any of R¹³ to R¹⁵ may form a cyclic structure,
R¹⁶O—R¹⁷—OR¹⁸ (5)
wherein R¹⁶ and R¹⁸ individually represent an alkyl group having 1 to 6 carbon atoms, a vinyl group, or a phenyl group, and R¹⁷ represents an alkylene group having 1 to 6 carbon atoms, an alkenylene group having 2 to 6 carbon atoms, or a phenyl group, provided that R¹⁶ and R¹⁸ may form a cyclic structure,
CₓH_{y} (6)
wherein x represents an integer from 4 to 20, and y represents an integer from 6 to 42, 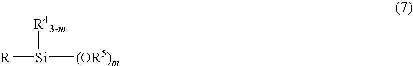
wherein R represents a monovalent organic group, R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, and m represents an integer from 0 to 2.

2. The method according to claim 1, wherein the organomagnesium compound shown by the general formula (1) is an organomagnesium compound shown by the following general formula (8), and the silicon compound shown by the general formula (7) is a silicon compound shown by the following general formula (9), 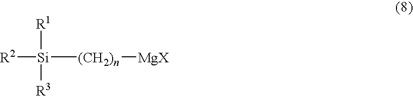
wherein R¹ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group, X represents a halogen atom, and n represents an integer from 1 to 3, 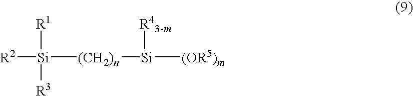
wherein R¹ to R³ individually represent a hydrogen atom, an alkyl group having 1 to 4 carbon atoms, a vinyl group, a phenyl group, a halogen atom, a hydroxyl group, an acetoxy group, a phenoxy group, or an alkoxy group, R⁴ individually represent a hydrogen atom, an alkyl group having 1 to 4 carbon atoms, a vinyl group, or a phenyl group, R⁵ represents an alkyl group having 1 to 4 carbon atoms, an acetyl group, or a phenyl group, m represents an integer from 0 to 2, and n represents an integer from 1 to 3.

3. The method according to claim 2, wherein n in the general formulas (8) and (9) is one.

4. The method according to claim 1, further comprising reacting an alkyl halide shown by the following general formula (10) with magnesium to produce the organomagnesium compound shown by the general formula (1),
RX (10)
wherein R represents a monovalent organic group, and X represents a halogen atom.
